(19) United States
(12) Patent Application Publication
(10) Pub. No.: US 2026/0258642 A1
(43) Pub. Date: Sep. 3, 2026

(54) WATER SUPPLY DEVICE

(71) Applicant: LG ELECTRONICS INC., Seoul (KR)

(72) Inventors: Wonkyu LEE, Seoul (KR); Young Joo CHO, Seoul (KR); Jae Kul LEE, Seoul (KR); Namyoung KIM, Seoul (KR); Hophil LEE, Seoul (KR); Jung Eun CHOI, Seoul (KR); Hyeok Jin KWON, Seoul (KR); Chul Bae LEE, Seoul (KR); Byeong Ki KANG, Seoul (KR)

(21) Appl. No.: 19/657,211

(22) Filed: Apr. 24, 2026

(30) Foreign Application Priority Data
Feb. 24, 2025 (KR) 10-2025-0023810

(51) Int. Cl. E03C 1/04

(52) U.S. Cl. CPC E03C 1/0404

(57) ABSTRACT

Proposed is a water supply device. The water supply device includes a base column (200) and a first rotating arm (300) configured to rotate about the base column (200) as a first rotation axis (RA1). A second rotating arm (400) configured to rotate about a second rotation axis (RA2) independently of the first rotation axis (RA1) is connected to the second rotation axis (RA2) rotating together with the first rotating arm (300). A first water outlet part (OP1) is connected to a first flow path extending inside the first rotating arm (300), and a second water outlet part (OP2) is connected to a second flow path extending inside the first rotating arm (300) and the second rotating arm (400). A water discharge position of the first water outlet part (OP1) is variable according to an angular position of the first rotating arm (300).

### CROSS REFERENCE TO RELATED APPLICATION

The present application claims priority to Korean Patent Application No. 10-2025-0023810, filed February 24, 2025, the entire contents of which are incorporated herein for all purposes by this reference.

### BACKGROUND OF THE INVENTION

### Field of the Invention

The present disclosure relates to a water supply device.

### Description of the Related Art

A water supply device is a device for supplying water to a user. When the user operates the water supply device, water stored in the water supply device or raw water supplied from outside may be supplied to the user through the water supply device. Examples of such a water supply device include a faucet or a water purifier used in a kitchen.

In general, the water supply device is configured such that a water outlet is fixed or rotates with a predetermined radius. Accordingly, a position of the water outlet is very limited and convenience of use is reduced. In addition, in order to fill water into a bowl located at a high position, a position of the water outlet is also required to be high. However, when the height of the water outlet is fixed, such work is inevitably very cumbersome.

In order to change the position of the water outlet, a hose structure is required to be applied. In this case, not only does a user have to pull the hose structure out and move it to a desired position, but also the user must continuously hold the water outlet because the water outlet cannot be fixed in that state.

Recently, a technology (Korean Patent Application Publication No. 10-2021-0124117) in which through a faucet and a water purifier having a plurality of water outlets, a user may obtain water at multiple positions has been disclosed. Although such a prior patent discloses the plurality of water outlets, the reachable range of the plurality of water outlets are fixed, and thus freedom of water discharge positions is still limited.

### Document of Related Art

(Patent Document 1) Korean Patent Application Publication No. 10-2021-0124117

### SUMMARY OF THE INVENTION

The present disclosure has been made to solve problems of the related art as described above, and an objective of the present disclosure is to allow a plurality of water outlet parts to supply water while being moved to various positions by a driving unit (motors).

Another objective of the present disclosure is to allow the water outlet parts to reach a distant position while a plurality of rotating arms are connected to each other and rotate independently.

Still another objective of the present disclosure is to prevent flow paths (tubes) extending through the plurality of rotating arms from being excessively bent or twisted due to rotational operations of the rotating arms.

Still another objective of the present disclosure is to improve aesthetics of a water supply device by making the flow paths and the rotating arms thin, while preventing a strong, narrow stream of water from being discharged from each of the water outlets as water pressure increases.

According to a feature of the present disclosure for achieving the objectives as described above, a water supply device of the present disclosure may include a base column and a first rotating arm configured to rotate about the base column as a first rotation axis. A second rotating arm configured to rotate about a second rotation axis independently of the first rotation axis may be connected to the second rotation axis rotating together with the first rotating arm. A first water outlet part may be connected to a first flow path extending inside the first rotating arm and the second rotation axis. A second water outlet part may be connected to a second flow path extending inside the first rotating arm, the second rotation axis, and the second rotating arm. A water discharge position of the first water outlet part may be variable according to an angular position of the first rotating arm. A water discharge position of the second water outlet part may be variable according to the angular position of the first rotating arm and an angular position of the second rotating arm. In this manner, as the rotating arms move to various positions, positions of the plurality of water outlet parts may also be variable.

A supply flow path may extend inside the first rotating arm and the second rotating arm. The supply flow path may be configured as a continuous flow path passing through the first rotating arm and the second rotating arm. Alternatively, the supply flow path may include a preceding flow path extending along the first rotating arm, and a following flow path extending along the second rotating arm and connected to the preceding flow path.

The water supply device may include a driving unit configured to rotate the first rotating arm and the second rotating arm.

The first flow path may be defined by a first flow path tube disposed inside the first rotating arm and a rotation link unit connecting the first rotating arm and the second rotating arm. The second flow path may be defined by a second flow path tube continuously disposed inside the first rotating arm, inside the rotation link unit, and inside the second rotating arm.

The second rotation axis may be formed by the rotation link unit connecting the first rotating arm and the second rotating arm. The first water outlet part may be disposed at a lower end portion of the rotation link unit.

The second rotation axis may be formed by the rotation link unit connecting the first rotating arm and the second rotating arm. The second water outlet part may be disposed at an end portion of the second rotating arm so as to be radially spaced apart from the rotation link unit.

Inside the first rotating arm, the first flow path and the second flow path may be disposed side by side to be parallel to each other with reference to a longitudinal direction of the first rotating arm.

The first water outlet part may be configured to rotate together with the first rotating arm such that the water discharge position of the first water outlet part is variable according to the angular position of the first rotating arm. The second water outlet part may be configured to rotate together with the second rotating arm such that the water discharge position of the second water outlet part is variable according to the angular position of the first rotating arm, the angular position of the second rotating arm, or a combination of the angular position of the first rotating arm and the angular position of the second rotating arm.

The second rotation axis may be formed by the rotation link unit connecting the first rotating arm and the second rotating arm. The second flow path may pass through an inside of the rotation link unit to form a continuous path from the first rotating arm to the second rotating arm.

The second rotation axis may be formed by the rotation link unit connecting the first rotating arm and the second rotating arm. The second flow path may extend inside the rotation link unit in an axial direction of the second rotation axis along a central portion of the second rotation axis.

The second flow path may include a first path portion extending inside the first rotating arm, a second path portion extending inside the second rotating arm and having an end connected to the second water outlet part, and a connection path portion connecting the first path portion and the second path portion and extending inside the rotation link unit.

The base column may extend in a first direction. The first rotation axis and the second rotation axis may each be formed in a direction parallel to the first direction.

The rotation link unit may include a first link flow path formed to be radially spaced apart from a center of the second rotation axis and connecting the first flow path and the first water outlet part. The rotation link unit may include a second link flow path formed coaxially with the center of the second rotation axis and configured to guide the second flow path along a direction of the second rotation axis.

The water supply device may further include a first flow path connector rotating together with the first rotating arm, and a second flow path connector configured to rotate together with the second rotating arm and aligned with the first flow path connector in a direction of the second rotation axis.

The first flow path connector and the second flow path connector may constitute a part of the first flow path along an axial direction of the second rotation axis at a location radially offset from a central portion of the second rotation axis.

The first flow path connector and the second flow path connector may constitute a part of the second flow path along the central portion of the second rotation axis.

The second flow path connector may have an inlet opening connected to an outlet of the first flow path connector. The outlet or the inlet may extend continuously in a circumferential direction corresponding to relative rotation between the first flow path connector and the second flow path connector, so that the outlet and the inlet may remain connected to each other during the relative rotation between the first flow path connector and the second flow path connector.

The first flow path may be defined by the first flow path tube disposed in the first rotating arm and the rotation link unit. The second flow path may be defined by the second flow path tube continuously disposed along the first rotating arm, the rotation link unit, and the second rotating arm.

Inside the rotation link unit, the first flow path may be formed in the direction of the second rotation axis while being radially spaced apart from the central portion of the rotation link unit. Inside the rotation link unit, the second flow path tube may extend in the direction of the second rotation axis along the central portion of the rotation link unit.

The rotation link unit may include the first flow path connector disposed inside the first rotating arm, configured to rotate together with the first rotating arm, and connected to an end portion of the first flow path. The rotation link unit may include the second flow path connector rotatably connected to the first flow path connector, disposed inside the second rotating arm and configured to rotate together with the second rotating arm, and configured to guide the second flow path toward the second rotating arm after the second flow path extends along the center of the second rotation axis.

The water supply device may include the first flow path connector connected to the end portion of the first flow path, disposed on the second rotation axis, and configured to rotate together with the first rotating arm, and the second flow path connector connected to the first flow path connector so as to be rotatable relative to the first flow path connector. The second flow path connector may rotate together with the second rotating arm about the second rotation axis, and may guide a path of the second flow path toward the second rotating arm. The first water outlet part may be formed in the second flow path connector.

The first link flow path continuously connecting the end portion of the first flow path and the first water outlet part may be defined inside the first flow path connector and the second flow path connector.

The first flow path connector may define a path of the first flow path connector having a first end connected to the first flow path and a second end open toward the second flow path connector. The second flow path connector may define a path of the second flow path connector connecting the first flow path connector path and the first water outlet part. In this case, the first flow path connector path and the second flow path connector path may be formed at positions radially spaced apart from the central portion of the second rotation axis.

The first flow path connector may be provided with a guide protrusion part protruding in the axial direction of the second rotation axis and having the first flow path connector path formed therein. The second flow path connector may be provided with a rotation guide into which the guide protrusion part is inserted and which forms the second flow path connector path. During relative rotation between the first rotating arm and the second rotating arm, the guide protrusion part may rotate along the rotation guide.

The rotation guide may extend in a circumferential direction about the second rotation axis. The guide protrusion part may be caught by opposite end portions of the rotation guide, thereby limiting a relative rotation angle between the first rotating arm and the second rotating arm.

The second flow path connector may include the rotation guide connected to the first flow path connector and configured to rotate relative to the first flow path connector, and a first nozzle coupled to the rotation guide and defining the first water outlet part. A first buffer chamber may be formed in the rotation guide and the first nozzle to allow water supplied from the first flow path to be collected and then discharged to the outside.

A buffer chamber may be formed in the first water outlet part or the second water outlet part to allow water supplied from the first flow path and the second flow path to be collected and then discharged to the outside.

The first water outlet part or the second water outlet part may include the buffer chamber in which water supplied from the first flow path or the second flow path is collected, and a nozzle chamber configured to discharge the water collected in the buffer chamber to the outside. In this case, a baffle wall may be disposed between the buffer chamber and the nozzle chamber. The water collected in the buffer chamber may move to the nozzle chamber over the baffle wall.

The base column may extend in the first direction, and the base column may linearly move in the first direction by the driving unit.

The water supply device may further include a driving frame in which the driving unit. The driving unit may include a linear driving source configured to move the base column in the first direction. The driving unit may include a rotation driving source configured to rotate the first rotating arm and the second rotating arm. The linear driving source may be configured to be fixed to the driving frame, and the rotation driving source may be configured to move together with the base column in the first direction by operation of the linear driving source.

The driving unit may be provided with a moving platform moved in the first direction in conjunction with the rotation of the linear driving source. The rotation driving source and the base column may be disposed on the moving platform, and the moving platform, the rotation driving source, and the base column may be configured to move together in the first direction.

The driving unit may include a plurality of rotation motors. The plurality of rotation motors may be configured to independently rotate the first rotating arm and the second rotating arm by respectively rotating a plurality of different driving belts.

Inside the base column, a first hub driving shaft may be disposed coaxially with the base column. The first hub driving shaft may be connected to a first rotation motor constituting the driving unit by a first hub belt and may be rotated by the first rotation motor. One end portion of the first rotating arm may be connected to the first hub driving shaft, so that the first rotating arm may rotate together with the first hub driving shaft.

Inside the base column, a second hub driving shaft may be disposed coaxially with the base column and the first hub driving shaft. One end portion of the second hub driving shaft may be connected to a second rotation motor constituting the driving unit by a second hub belt and may be rotated by the second rotation motor. The other end portion of the second hub driving shaft may be connected to the second rotation axis by a sub-belt, so that the second rotating arm may rotate together with the second hub driving shaft.

The first rotating arm and the second rotating arm may be configured to rotate on an X-Y plane formed in a direction orthogonal to the first direction.

A camera facing the first direction may be disposed on at least one of the first rotating arm and the second rotating arm, or a proximity sensor may be disposed on at least one of the first rotating arm and the second rotating arm.

A lighting device configured to emit light toward a direction in which the first water outlet part and the second water outlet part are open may be disposed on at least one of the first rotating arm and the second rotating arm.

The driving unit may include the driving frame, the linear driving source configured to linearly move the base column and to be fixed to the driving frame, and the rotation driving source configured to rotationally move the plurality of rotating arms and to move together with the base column and the plurality of rotating arms in the first direction by the linear driving source.

The first water outlet part may be configured to rotate together with the first rotating arm such that the water discharge position of the first water outlet part is variable according to the angular position of the first rotating arm. The second water outlet part may be configured to rotate together with the second rotating arm such that the water discharge position of the second water outlet part is variable according to the angular position of the first rotating arm, the angular position of the second rotating arm, or the combination of the angular position of the first rotating arm and the angular position of the second rotating arm.

The water supply device according to the present disclosure as described above may have the following effects.

According to the present disclosure, the plurality of water outlet parts may be disposed on the rotating arms. As the rotating arms are moved to various positions by the driving unit, positions of the plurality of water outlet parts may also be variable. Accordingly, a user may supply water to a desired position as needed, thereby improving convenience of use of the water supply device.

In addition, in the present disclosure, the plurality of rotating arms may be connected to each other and may independently rotate. When the plurality of rotating arms is unfolded relative to each other, the water outlet part may reach a position corresponding to a sum of lengths of the plurality of arms. Accordingly, an operating range of the water supply device may be expanded.

Further, in the present disclosure, the flow paths extending through the plurality of rotating arms may be free from rotational operations of the rotating arms by extending through the centers of the rotation axes at which the rotating arms are connected to each other. Through this, the flow paths extending through the plurality of rotating arms may not be excessively bent or twisted by the rotations of the rotating arms, thereby improving durability of the flow paths and maintaining smooth water flow.

Further, in the present disclosure, the rotation link unit may be disposed at a portion where the plurality of rotating arms is connected to each other. The rotation link unit includes the two flow path connectors connected to each other, and the two flow path connectors may constitute parts of the first flow path and the second flow path. These two connectors may relatively rotate together when the two rotating arms rotate relative to each other, so that the first flow path and the second flow path remain connected to each other without being disconnected. Accordingly, even when the rotating arms freely rotate, connected states of the flow paths may be maintained irrespective thereof, and operational reliability thereof may be improved.

In particular, in the present disclosure, a part of the first flow path of the two flow paths may be formed by the first flow path tube, and the remaining part of the first flow path may be formed by the rotation link unit. That is, the first water outlet part, which is an outlet of the first flow path, may be defined by the rotation link unit. In this case, a part of the flow path tube, which is likely to be twisted or bent, may be omitted, thereby obtaining a more stable and consistent water discharge function.

In addition, in the present disclosure, the buffer chamber may be formed in the water outlet part from which water is discharged. The buffer chamber may guide water to be first collected to some extent before being discharged. Accordingly, a phenomenon in which a strong, narrow stream of water is discharged from the water outlet part due to high water pressure may be prevented, thereby improving usability of the water supply device.

Further, the buffer chamber is present, and thus even when the flow path is made thin, formation of a strong stream of water only in a specific direction may be prevented. Accordingly, the flow path and the rotating arms may be designed to be thin, and aesthetic completeness of the water supply device may be enhanced.

In addition, in the present disclosure, the plurality of rotating arms may be moved up and down together with the base column. The plurality of rotating arms may perform more diverse and precise movements while rotating together with the up-and-down movement. Such movements of the plurality of rotating arms may provide more diverse functions to the water supply device, thereby increasing utility of the water supply device.

Further, in the present disclosure, the rotating arms may be provided with cameras. The cameras may operate together with the rotating arms and may capture surroundings of the water supply device at various positions. Accordingly, a user may observe all of a wide area around the water supply device, for example, an upper area of a sink, and through this, appropriate functions may be actively provided to the user.

In addition, the rotating arms of the present disclosure may be provided with proximity sensors. The proximity sensors may prevent collision between the rotating arms and surrounding facilities or stored objects. Accordingly, operational stability and durability of the water supply device may be improved.

### BRIEF DESCRIPTION OF THE DRAWINGS

The above and other objectives, features, and other advantages of the present disclosure will be more clearly understood from the following detailed description when taken in conjunction with the accompanying drawings, in which:

FIG. 1 (a) to (c) are operation state views sequentially illustrating an operation of a water supply device according to a first embodiment of the present disclosure;

FIG. 2 is a perspective view illustrating configurations of a base column and rotating arms according to the first embodiment of the present disclosure;

FIG. 3 is a perspective view illustrating the first embodiment of the present disclosure;

FIG. 4 (a) to (c) are operation state views sequentially illustrating an operation of a water supply device according to a second embodiment of the present disclosure;

FIG. 5 is a perspective view illustrating configurations of a base column and rotating arms according to the second embodiment of the present disclosure;

FIG. 6 is a perspective view illustrating the second embodiment of the present disclosure;

FIG. 7 is a perspective view illustrating a rotation driving source according to the second embodiment of the present disclosure;

FIG. 8 is a perspective view illustrating a linear driving source according to the second embodiment of the present disclosure;

FIG. 9 is a sectional view illustrating a structure according to the second embodiment of the present disclosure;

FIG. 10 is a sectional view taken along line X-X' of FIG. 6;

FIG. 11 is an exploded perspective view illustrating a first rotating arm, a second rotating arm, and a rotation link unit according to the second embodiment of the present disclosure;

FIG. 12 is a perspective view illustrating a first flow path tube and a second flow path tube, with a first arm cover according to the second embodiment of the present disclosure removed;

FIG. 13 is a sectional view taken along line XIII-XIII' of FIG. 5;

FIG. 14 is a sectional view illustrating internal structures of the first rotating arm, the second rotating arm, and the rotation link unit according to the second embodiment of the present disclosure;

FIG. 15 is a perspective view illustrating internal structures of the first rotating arm and the second rotating arm according to the second embodiment of the present disclosure, with housings thereof removed;

FIG. 16 is a perspective view illustrating a structure around the rotation link unit according to the second embodiment of the present disclosure;

FIG. 17 is a perspective view illustrating a state in which the first flow path tube and the second flow path tube are connected to the rotation link unit according to the second embodiment of the present disclosure;

FIG. 18 is an exploded perspective view illustrating components of the rotation link unit according to the second embodiment of the present disclosure;

FIG. 19 is an exploded perspective view illustrating a first flow path connector and a second flow path connector constituting the rotation link unit of the second embodiment of the present disclosure;

FIG. 20 is a sectional view taken along line XX-XX' of FIG. 17;

FIG. 21 is a sectional view illustrating a state in which the first flow path tube and the second flow path tube are removed from FIG. 20;

FIG. 22 is an exploded sectional view illustrating the first flow path connector and the second flow path connector constituting the rotation link unit according to the second embodiment of the present disclosure;

FIG. 23 is a sectional view illustrating the structure of the second flow path connector constituting the rotation link unit according to the second embodiment of the present disclosure;

FIG. 24 is a perspective view illustrating a state in which the second flow path tube is connected to a nozzle unit constituting a second water outlet part according to the second embodiment of the present disclosure;

FIG. 25 is an exploded perspective view illustrating a connection guide and a second nozzle constituting the nozzle unit according to the second embodiment of the present disclosure;

FIG. 26 is a sectional view taken along line XXVI-XXVI' of FIG. 24; and

FIG. 27 is a perspective view illustrating a state in which the water supply device according to the present disclosure is applied to a water purifier.

### DETAILED DESCRIPTION OF THE INVENTION

Hereinafter, some embodiments of the present disclosure will be described in detail with reference to exemplary drawings. In assigning reference numerals to components of each drawing, it should be noted that the same reference numerals are assigned to the same components as much as possible, even if they are shown in different drawings. Furthermore, in describing the embodiments of the present disclosure, detailed descriptions of well-known configurations or functions will be omitted when it is determined that such descriptions may obscure the understanding of the embodiments of the present disclosure.

A water supply device according to an embodiment of the present disclosure may be configured such that a plurality of components thereof move freely, thereby enabling water to be discharged to various positions. To this end, the water supply device of the present embodiment may include a first rotating arm 300 and a second rotating arm 400, which rotate independently of each other, and a base column 200 that linearly moves together therewith. Hereinafter, the structures of the first rotating arm 300, the second rotating arm 400, and the base column 200, and the structure of a driving unit 100 for driving them, will be described in detail.

Meanwhile, inside the water supply device, flow path tubes WT1 and WT2 for supplying water may be disposed in the first rotating arm 300 and the second rotating arm 400. Although the flow path tubes WT1 and WT2 may be excessively bent during relative rotation between the first rotating arm 300 and the second rotating arm 400, in the present embodiment, such bending and twisting may be prevented through a structure including a rotation link unit 500. A structure thereof will be described in detail below.

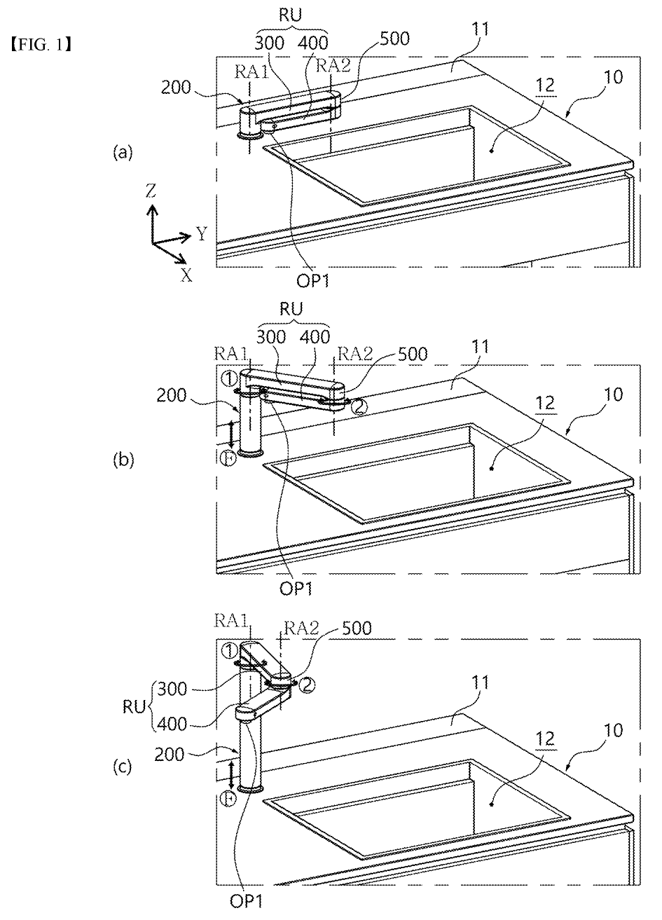

With reference to FIGS. 1A, 1V, 1C, 2, and 3, a first embodiment of the present disclosure will be described. In the present embodiment, the water supply device may include one water outlet part, more specifically, a first water outlet part OP1. The first water outlet part OP1 may be positioned at various locations by operations of the two rotating arms 300 and 400 and may provide various water discharge positions to a user.

With reference to FIGS. 1A, 1B, 1C, 2, and 3, the first embodiment of the present disclosure will be described. First, briefly looking at a structure of a sink 10, a sink bowl 12 may be provided in a main body 11 of the sink 10. The water supply device may be disposed at a position adjacent to the sink bowl 12 to discharge water into the sink bowl 12. For example, the water supply device may discharge water for washing dishes or food ingredients, such as fruits, contained in the sink bowl 12, or may discharge drinking water for a user to drink.

Referring to FIGS. 1A, 1B, and 1C, a process in which the water supply device is operated is sequentially illustrated. FIG. 1A illustrates the water supply device in a default state. The default state means a state in which the water supply device has a lowest height and, at the same time, the first rotating arm 300 and the second rotating arm 400 constituting a rotation unit RU are folded relative to each other. When the first rotating arm 300 and the second rotating arm 400 are folded, the first rotating arm 300 and the second rotating arm 400 may overlap each other in a first direction. In this state, the base column 200 may linearly move in the first direction.

Referring to FIG. 1B, the base column 200 is illustrated as being raised, and the first rotating arm 300 and the second rotating arm 400 are also illustrated as being raised together therewith. Here, the first direction is a height direction, that is, a Z-axis direction, and an X-axis and a Y-axis respectively indicate a front-rear direction and a left-right direction. The first rotating arm 300 may rotate about the base column 200 as a first rotation axis RA1, and the second rotating arm 400 may rotate about a second rotation axis RA2 independently of the first rotating arm 300.

Referring to FIG. 1C, a state in which the first rotating arm 300 and the second rotating arm 400 are unfolded is illustrated. The first water outlet part OP1 disposed at an end portion of the second rotating arm 400 may be positioned at various locations on an X-Y plane by rotations of the first rotating arm 300 and the second rotating arm 400.

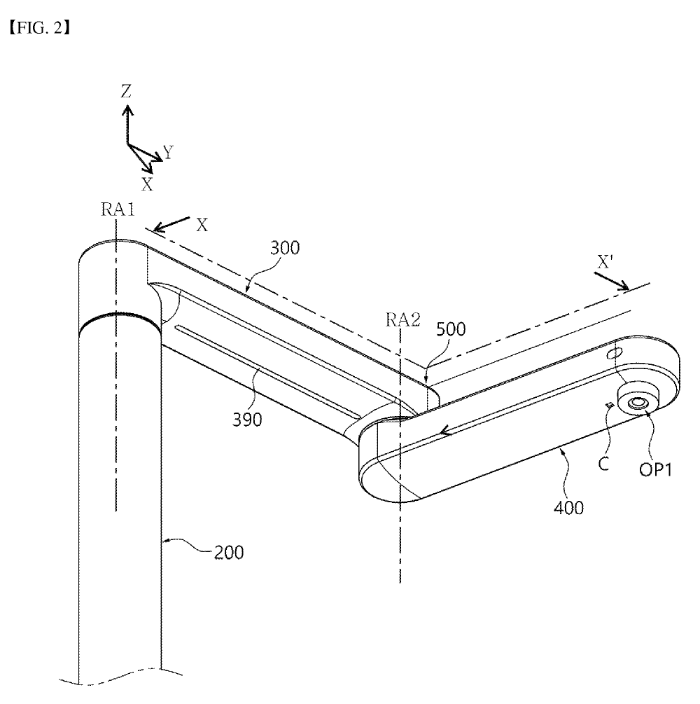

Referring to FIG. 2, the first water outlet part OP1 is illustrated. In the first embodiment, the first water outlet part OP1 may be disposed at the end portion of the second rotating arm 400. The first rotating arm 300 and the second rotating arm 400 may be connected by the rotation link unit 500, and the rotation link unit 500 may constitute the second rotation axis RA2.

Inside the first rotating arm 300 and the second rotating arm 400, the flow path tubes WT1 and WT2 may be disposed to respectively form a first flow path and a second flow path. Reference numeral 390 denotes a lighting device 390. The lighting device 390 may emit light downward to increase illuminance around the water supply device. The second rotating arm 400 may be provided with a camera C configured to capture surroundings. The camera C may be disposed at a lower portion of the second rotating arm 400 adjacent to the first water outlet part OP1.

A supply flow path may extend along insides of the first rotating arm and the second rotating arm. The water outlet part may receive water through the supply flow path and discharge the water to the outside.

The supply flow path may be configured as a continuous flow path passing through the first rotating arm and the second rotating arm. Alternatively, the supply flow path may include a preceding flow path extending along the first rotating arm, and a following flow path extending along the second rotating arm and connected to the preceding flow path.

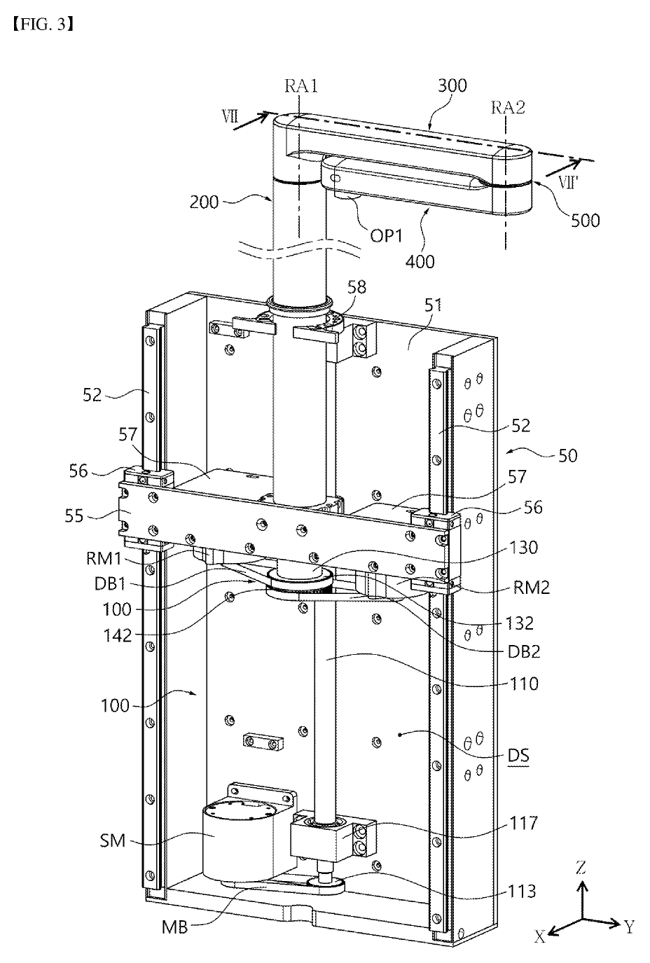

Referring to FIG. 3, an overall structure of the water supply device according to the first embodiment of the present disclosure is illustrated. Components such as a driving frame 50 and a guidepost 110 may be accommodated inside the main body 11 of the sink 10. Accordingly, only a portion of the base column 200, the first rotating arm 300, and the second rotating arm 400 may be exposed to the outside of the main body 11.

The driving frame 50 may include a driving chamber DS in which a plurality of motors SM, RM1, and RM2 constituting the driving unit 100 and a moving platform 55 are disposed. The driving frame 50 may include a driving plate 51. The moving platform 55 may be moved in the first direction along movement rails 52 of the driving frame 50, and opposite end portions 56 of the moving platform 55 may be guided by the movement rails 52.

The moving platform 55 may include motor casings 57 on which rotation motors RM1 and RM2 may respectively be mounted, and linear movement of the moving platform 55 may be driven by a linear driving motor SM. The moving platform 55 and the base column 200 may be connected to each other by a lifting bracket 59, and the moving platform 55 may be provided with a lifting guide 58 configured to reduce friction when the base column 200 moves upward and downward. Since such a structure of the first embodiment is similar to a structure of a second embodiment to be described later, the structure will be described together in the second embodiment.

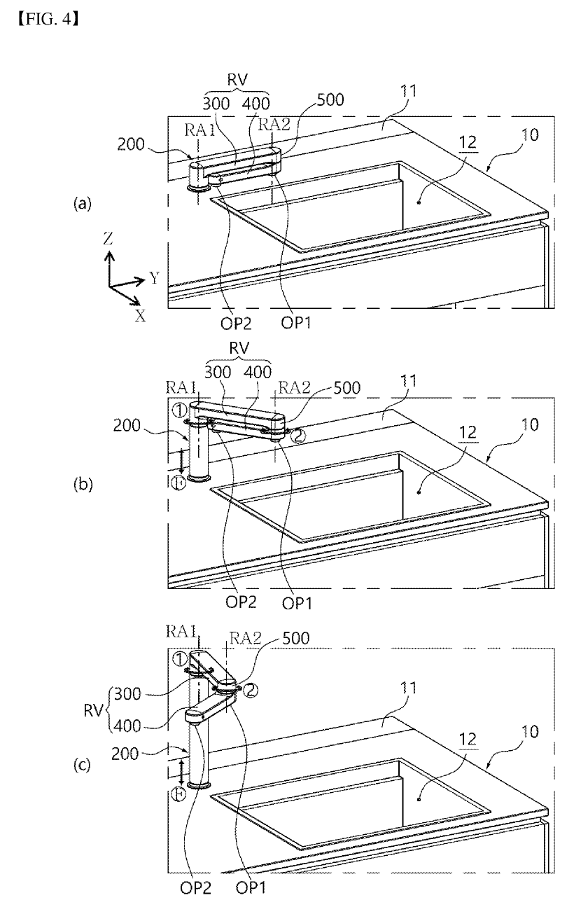

Referring to FIGS. 4A, 4B, and 4C, a water supply device according to the second embodiment of the present disclosure which is applied to a sink 10 is illustrated. Looking at differences from the first embodiment described above, in the second embodiment, the water supply device may include two water outlet parts, more specifically, a first water outlet part OP1 and a second water outlet part OP2. The two water outlet parts OP1 and OP2 may be positioned at various locations by operations of two rotating arms 300 and 400 and may provide various water discharge positions to a user.

Referring to FIGS. 4A, 4B, and 4C, a process in which the water supply device is operated is sequentially illustrated. First, FIG. 4A illustrates the water supply device in a default state. Here, the default state means a state in which the water supply device has a lowest height and, at the same time, the first rotating arm 300 and the second rotating arm 400 constituting a rotation unit RU are folded relative to each other. When the first rotating arm 300 and the second rotating arm 400 are folded, the first rotating arm 300 and the second rotating arm 400 may overlap each other in the first direction.

In the second embodiment, linear movement of a base column 200 and rotational operations of the first rotating arm 300 and the second rotating arm 400 are the same as those in the first embodiment described above, and thus a detailed description thereof will be omitted.

In this state, the base column 200 may linearly move. Referring to FIG. 4B, the base column 200 is illustrated as being raised, and the first rotating arm 300 and the second rotating arm 400 are also illustrated as being raised together therewith. Accordingly, heights of the first water outlet part OP1 and the second water outlet part OP2 disposed on the second rotating arm 400 may also be increased. As such, the base column 200 may linearly move in the first direction. In FIG. 4B, the first direction is illustrated as a Z-axis direction, which is a height direction. In FIG. 4B, an X-axis and a Y-axis respectively indicate a front-rear direction and a left-right direction. Hereinafter, description will be made on the basis of these directions.

The first rotating arm 300 may rotate about the base column 200 as a first rotation axis RA1. The second rotating arm 400 may rotate about a second rotation axis RA2 formed on the first rotating arm 300 independently of the first rotating arm 300. The rotations of the first rotating arm 300 and rotation of the second rotating arm 400 may be performed simultaneously with the linear movement of the base column 200. In this case, the first water outlet part OP1 may rotate together with the first rotating arm 300, such that a water discharge position thereof is variable according to an angular position of the first rotating arm 300. The second water outlet part OP2 may rotate together with the second rotating arm 400, such that a water discharge position thereof is variable according to an angular position of the first rotating arm 300, an angular position of the second rotating arm 400, or a combination of the angular positions of the first rotating arm 300 and the second rotating arm 400.

Referring to FIG. 4C, a state in which the first rotating arm 300 and the second rotating arm 400 are unfolded is illustrated. Here, the unfolded state means a state in which the second rotating arm 400 rotates with respect to the first rotating arm 300 such that an end portion of the second rotating arm 400 is farther away from the base column 200. When the first rotating arm 300 and the second rotating arm 400 are unfolded in this manner, the second water outlet part OP2 provided at the end portion of the second rotating arm 400 may be farther away from the base column 200, such that the second water outlet part OP2 may reach a farther position. The first water outlet part OP1 and the second water outlet part OP2 may be positioned at various locations on the X-Y plane by rotations of the first rotating arm 300 and the second rotating arm 400.

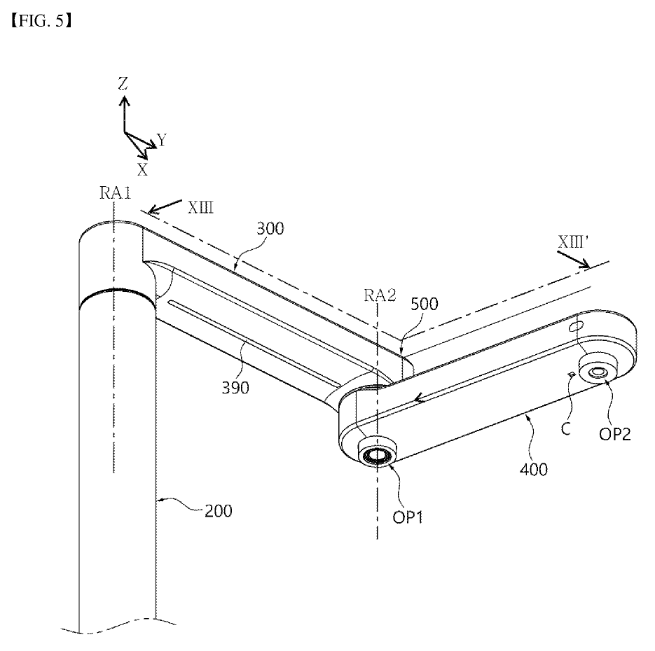

Referring to FIG. 5, the first water outlet part OP1 and the second water outlet part OP2 are illustrated. The first water outlet part OP1 and the second water outlet part OP2 may be disposed at a lower portion of the second rotating arm 400. More specifically, the first water outlet part OP1 may be disposed on the second rotation axis RA2, and the second water outlet part OP2 may be disposed at an end portion of the second rotating arm 400. In this case, a position of the first water outlet part OP1 may be varied by rotation of the first rotating arm 300. A position of the second water outlet part OP2 may be varied by rotation of the first rotating arm 300, rotation of the second rotating arm 400, or a combination of the rotations of the first rotating arm 300 and the second rotating arm 400. As another example, the first water outlet part OP1 may be disposed on the first rotating arm 300.

Reference numeral 390 denotes a lighting device 390. The lighting device 390 may emit light downward to increase illuminance around the water supply device. The lighting device 390 may emit light when the water supply device is used, thereby improving user convenience. The lighting device 390 may emit light downward so that a camera C, illustrated in FIG. 5, may acquire an image of surroundings more clearly.

Different types of water may be discharged from the first water outlet part OP1 and the second water outlet part OP2. For example, water for washing may be supplied through the first water outlet part OP1, and drinking water may be supplied through the second water outlet part OP2. Conversely, drinking water may be supplied through the first water outlet part OP1, and water for washing may be supplied through the second water outlet part OP2. Alternatively, a beverage or a cleaning agent, rather than water, may be supplied through one of the first water outlet part OP1 and the second water outlet part OP2. As another example, high-pressure air may be discharged through one of the first water outlet part OP1 and the second water outlet part OP2 for a purpose such as drying.

Accordingly, in the present embodiment, the first water outlet part OP1 and the second water outlet part OP2 may constitute independent water outlet parts. Water may be discharged simultaneously from the first water outlet part OP1 and the second water outlet part OP2, or water may be discharged only through one of the first water outlet part OP1 and the second water outlet part OP2. A structure for independently supplying separate water to the first water outlet part OP1 and the second water outlet part OP2 will be described again below.

Referring to FIG. 5, the second rotating arm 400 may be provided with a camera C configured to capture surroundings. The camera C may be disposed on the second rotating arm 400 so as to face a bottom of the sink 10. In the present embodiment, the camera C may be disposed at a lower portion of the second rotating arm 400 adjacent to the second water outlet part OP2. A drive controller (not shown) may control operations of the rotating arms 300 and 400 on the basis of one or more pieces of information among a type, a size, and a color of a surrounding object, such as a container, acquired by the camera C. For example, when the container acquired by the camera C is a coffee pot, the drive controller may drive the first rotating arm 300, the second rotating arm 400, and the base column 200 so that high-temperature water is supplied from the second water outlet part OP2 to the coffee pot while rotating, thereby implementing a drip coffee preparation function. As another example, the camera C may be provided on the first rotating arm 300 or the base column 200 or may be provided on each of the first rotating arm 300 and the base column 200. A control process by the drive controller will be described again below.

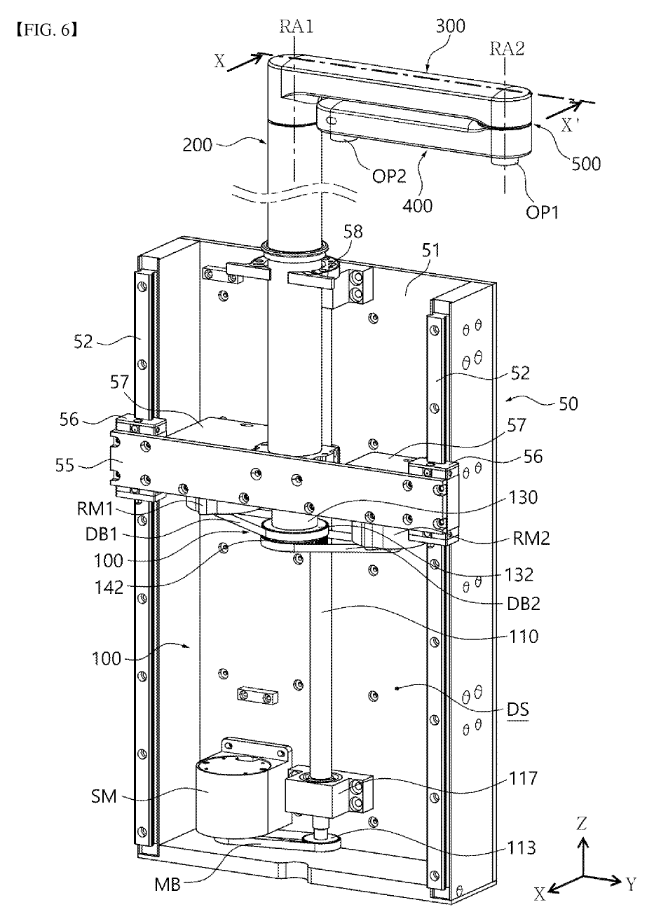

Referring to FIG. 6, an overall structure of the water supply device according to the present embodiment is illustrated. Components such as the driving frame 50 and the guidepost 110 may be accommodated inside the main body 11 of the sink 10. Accordingly, only a portion of the base column 200, the first rotating arm 300, and the second rotating arm 400 may be exposed to an outside of the main body 11 of the sink 10.

Driving sources for linear movement of the base column 200 and rotational movement of the first rotating arm 300 and the second rotating arm 400 may be disposed in the driving frame 50. A driving chamber DS may be formed inside the driving frame 50. The driving chamber DS may be defined by the driving frame 50. The driving frame 50 may be disposed inside the main body 11 of the sink 10 and may surround the driving chamber DS. The driving frame 50 may provide a place where the driving unit 100 is fixed and may guide movement of a moving platform 55 in the first direction, which will be described below.

A plurality of motors SM, RM1, and RM2 constituting the driving unit 100 may be arranged inside the driving chamber DS in a left-right direction, that is, in a Y-axis direction. Through this, a volume occupied by the plurality of motors SM, RM1, and RM2 in a front-rear direction, that is, in an X-axis direction, may be reduced, and installation and maintenance of the plurality of motors SM, RM1, and RM2 may be facilitated.

As illustrated in FIG. 6, the driving unit 100 may include the plurality of motors SM, RM1, and RM2, and some RM1 and RM2 of the plurality of motors may be guided by the driving frame 50 of the driving unit 100 to linearly move in the first direction. The driving frame 50 constituting the driving unit 100 may include a driving plate 51 having a flat plate structure and may have a substantially rectangular frame shape. In the driving chamber DS defined by the driving frame 50, the plurality of motors SM, RM1, and RM2 constituting the driving unit 100 and the moving platform 55 may be disposed.

The moving platform 55 may be moved in the first direction along the driving frame 50. On the basis of the drawing, the moving platform 55 may be moved in an up-down direction. The opposite end portions 56 of the moving platform 55 may respectively move along movement rails 52 provided on the driving frame 50. A driving force for the linear movement of the moving platform 55 may be generated by a linear driving motor SM of the driving unit 100.

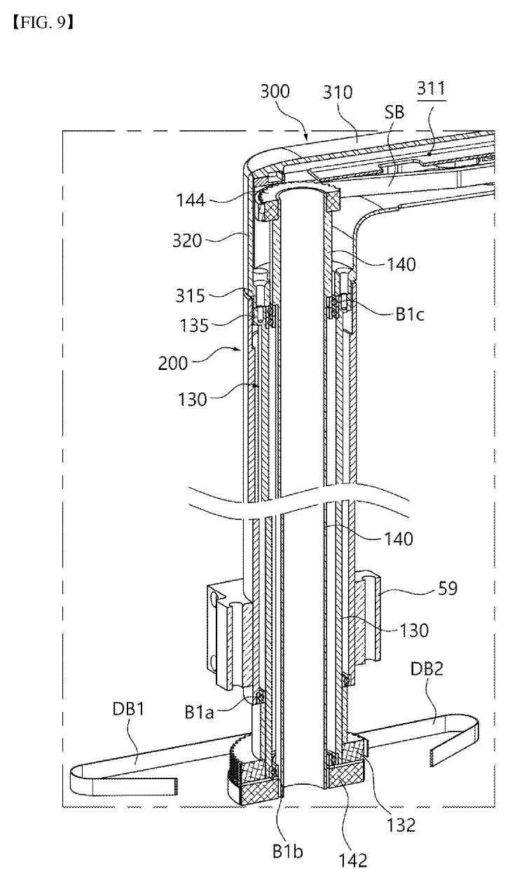

Motor casings 57 may be provided on the moving platform 55 such that the motor casings 57 may be moved up and down together therewith. The plurality of rotation motors RM1 and RM2 may respectively be mounted on the motor casings 57. Accordingly, the moving platform 55 and the motor casings 57 may move the plurality of rotation motors RM1 and RM2, and, in this process, the base column 200, the first rotating arm 300, and the second rotating arm 400 may be moved together therewith. In FIG. 9, reference numeral 59 denotes a lifting bracket connecting the base column 200 and the moving platform 55. The base column 200 may be moved along the moving platform 55 by the lifting bracket 59. As another example, the motor casings 57 may be omitted, and the plurality of rotation motors RM1 and RM2 may be directly mounted on the moving platform 55.

The base column 200 may be connected to the moving platform 55. The base column 200 may extend in the first direction. The base column 200 may linearly move the first rotating arm 300 and the second rotating arm 400 while linearly moving in the first direction along the moving platform 55. The first rotating arm 300 is coupled to the base column 200, and thus when the base column 200 is moved up and down on the basis of the drawings, the first rotating arm 300 and the second rotating arm 400 connected to the first rotating arm 300 may also be moved up and down together therewith. The moving platform 55 may be provided with a lifting guide 58 to reduce friction during raising and lowering of the base column 200. The lifting guide 58 may be configured as a bearing.

The base column 200 may linearly move in the first direction along the moving platform 55, and the first rotating arm 300 and the second rotating arm 400 may simultaneously perform rotational movement. The base column 200 and the first rotating arm 300 and the second rotating arm 400 may be configured to move among a plurality of points around the sink 10 by a combination of the linear movement and the rotational movement.

The driving frame 50 may be provided with the guidepost 110 for movement of the moving platform 55 and the base column 200 in the first direction. The moving platform 55 may be moved along the guidepost 110. A post pulley 113 belt-coupled to the linear driving motor SM may be provided at a lower end of the guidepost 110. The guidepost 110 may be rotated by the post pulley 113.

A driving nut (not shown) may be coupled to the guidepost 110. The guidepost 110 may be configured as a lead screw such that the driving nut may linearly move in the first direction along the guidepost 110. The driving nut may be coupled to the moving platform 55 or the motor casings 57 to move the moving platform 55. As another example, a ball screw, rather than a lead screw, may be applied to the guidepost 110. As still another example, the guidepost 110 may be configured as a structure tensioned by hydraulic pressure. Reference numeral 117 denotes a rotation support block for supporting rotation of the guidepost 110.

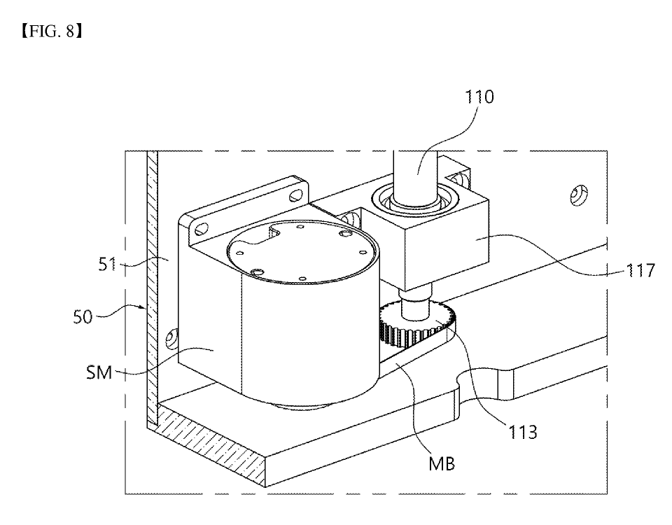

FIG. 8 illustrates a lower structure of the driving frame 50. In FIG. 8, among the plurality of motors SM, RM1, and RM2 constituting the driving unit 100, only the linear driving motor SM is illustrated. The linear driving motor SM may remain fixed to a lower portion of the driving frame 50. The linear driving motor SM may be fixed to the lower portion of the driving frame 50 to rotate the guidepost 110, and accordingly, the moving platform 55 may be moved in the first direction. Reference numeral MB denotes a linear driving belt configured to transmit rotational force of the linear driving motor SM to the post pulley 113.

On the other hand, the plurality of rotation motors RM1 and RM2 may not be fixed and may linearly move in the first direction together with the moving platform 55. The plurality of rotation motors RM1 and RM2 may remotely operate the rotation unit RU through a plurality of rotation driving belts DB1 and DB2. The linear driving motor SM may be regarded as a linear driving source, and the plurality of rotation motors RM1 and RM2 may be regarded as rotation driving sources.

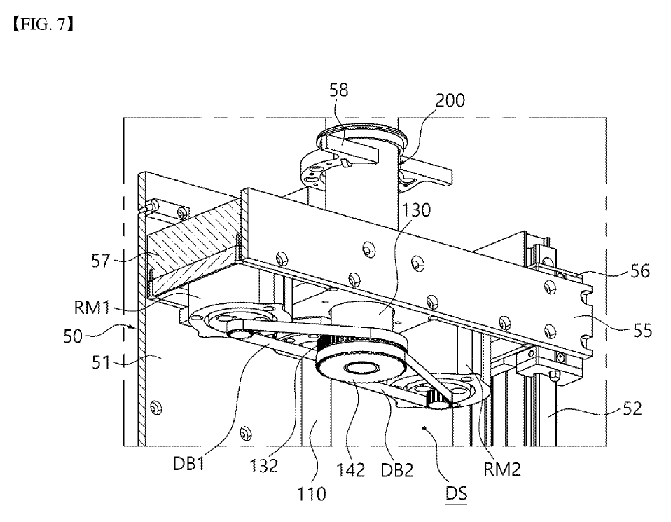

Referring to FIG. 7, the plurality of rotation motors RM1 and RM2 and the plurality of rotation driving belts DB1 and DB2 are illustrated. The plurality of rotation motors RM1 and RM2 may include a first rotation motor RM1 and a second rotation motor RM2. The first rotation motor RM1 may be connected to a first hub pulley 132 through a first driving belt DB1. The second rotation motor RM2 may be connected to a second hub pulley 142 through a second driving belt DB2. The first hub pulley 132 and the second hub pulley 142 may be disposed coaxially but rotate independently of each other.

Referring to FIG. 9, which is a sectional view, together with FIG. 7, when the first rotation motor RM1 rotates the first hub pulley 132, a first hub driving shaft 130 may be rotated. Since the first hub pulley 132 is coupled to a lower end portion of the first hub driving shaft 130, the first hub driving shaft 130 may be rotated by the first rotation motor RM1. The first hub driving shaft 130 may be disposed inside the base column 200 coaxially with the base column 200 and may be moved in the first direction together with the base column 200. Reference numeral B1a denotes a bearing disposed between the base column 200 and the first hub driving shaft 130.

Referring to an upper portion of FIG. 9, a first rotation block 135 may be provided at an upper end portion of the first hub driving shaft 130. No separate belt is wound around the first rotation block 135, and the first rotating arm 300 may be connected thereto. More specifically, a first housing connection part 315 provided on a first arm housing 310 of the first rotating arm 300 may be coupled to the first rotation block 135. The first housing connection part 315 and the first rotation block 135 may be fastened to each other by a fastener such as a screw. Accordingly, the first rotating arm 300 may be configured to rotate together with the first hub driving shaft 130. That is, when the first hub driving shaft 130 rotates, the first rotating arm 300 coupled thereto may rotate. Reference numeral 311 denotes a first housing space 311 inside the first arm housing 310, and a connection pulley 144 and a sub-belt SB, which will be described later, may be disposed in the first housing space 311.

Referring to FIGS. 7 and 9, when the second rotation motor RM2 rotates the second hub pulley 142 through the second driving belt DB2, a second hub driving shaft 140 may be rotated. Since the second hub pulley 142 is coupled to a lower end portion of the second hub driving shaft 140, the second hub driving shaft 140 may be rotated by the second rotation motor RM2. The second hub driving shaft 140 may be disposed inside the base column 200 coaxially with the base column 200 and the first hub driving shaft 130 and may be moved in the first direction together with the base column 200. Reference numeral B1b denotes a bearing disposed between the first hub driving shaft 130 and the second hub driving shaft 140.

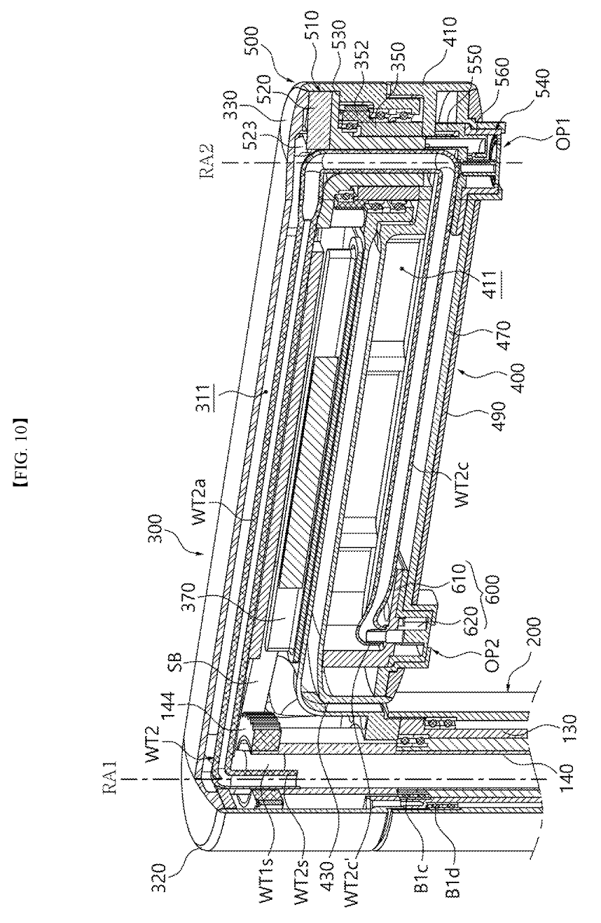

Referring to an upper portion of FIG. 9, the connection pulley 144 is provided at an upper end portion of the second hub driving shaft 140, and the second hub driving shaft 140 may be configured to rotate together with the second hub pulley 142 and the connection pulley 144. When the second hub pulley 142 of the second hub driving shaft 140 rotates, the connection pulley 144 integrally coupled thereto may rotate therewith. In this case, the connection pulley 144 may be connected through a hub belt SB to a sub-pulley 352 (shown in FIG. 10), which will be described below. Since the connection pulley 144 is coupled to the second rotating arm 400, rotation of the sub-pulley 352 may lead to a rotational operation of the second rotating arm 400. As a result, rotation of the second hub driving shaft 140 may operate in cooperation with rotation of the second rotating arm 400.

The plurality of hub driving shafts 130 and 140 may rotate independently of each other to implement various operations. For this purpose, as illustrated in FIG. 9, bearings B1b and B1c may be disposed between the first hub driving shaft 130 and a second hub driving shaft 140 to be described later, so that rotation between the hub driving shafts 130 and 140 is smoothly performed.

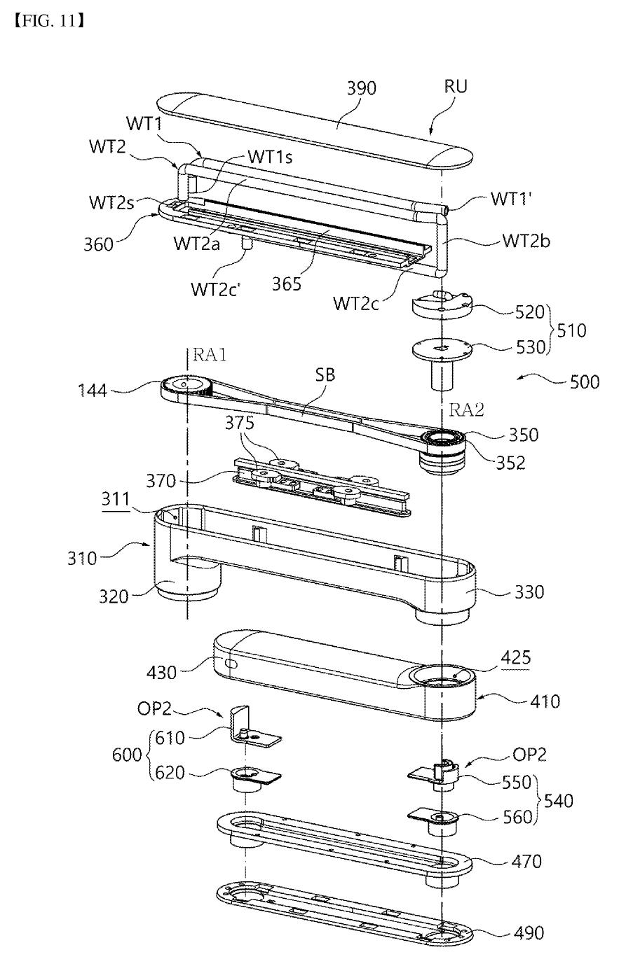

With reference to FIGS. 10 and 11, the first rotating arm 300 and the second rotating arm 400 will be described. The first rotating arm 300 and the second rotating arm 400 may rotate about the first rotation axis RA1 and the second rotation axis RA2, respectively. Since the first rotation axis RA1 is formed by the base column 200, the base column 200 may be referred to as the first rotation axis RA1. The second rotation axis RA2 may be formed at the other end portion of the first rotating arm 300 and may move together with the first rotating arm 300. That is, the first rotation axis RA1 is fixed on the X-Y plane, whereas the second rotation axis RA2 may move on the X-Y plane.

In the present embodiment, the base column 200 may extend in the first direction, and the first rotation axis RA1 and the second rotation axis RA2 may each be formed in a direction parallel to the first direction. However, as will be described later, the first rotating arm 300 and the second rotating arm 400 may have different heights with reference to the first direction.

A first flow path and a second flow path may respectively be formed inside the first rotating arm 300 and the second rotating arm 400. The first flow path and the second flow path may respectively constitute flow paths independent of each other. Different types of water or fluids may be delivered through the first flow path and the second flow path. In the present embodiment, the first flow path may extend along the first rotating arm 300 and the rotation link unit 500, and the second flow path may extend along the first rotating arm 300, the rotation link unit 500, and the second rotating arm 400.

Referring to FIG. 10, one end portion WT1s of a first flow path tube WT1 forming the first flow path and one end portion WT2s of a second flow path tube WT2 forming the second flow path are each illustrated as being cut off at one end portion of the first arm housing 310. However, the one end portion WT1s of the first flow path tube WT1 and the one end portion WT2s of the second flow path tube WT2 may each extend further downward along the base column 200 and may be connected to a water supply source. Here, the water supply source may include a raw water nozzle for supplying external tap water, a water purification device, or another water tank. As another example, the first flow path may be formed not only by the first flow path tube WT1 but also by a flow path (not shown) integrally formed inside the first rotating arm 300 and the rotation link unit 500. As still another example, the second flow path may be formed not only by the second flow path tube WT2 but also by a flow path (not shown) integrally formed inside the first rotating arm 300, the rotation link unit 500, and the second rotating arm 400.

For convenience of description, the first flow path tube WT1 and the second flow path tube WT2 will first be described. In FIG. 10, one end portion WT1s of the first flow path tube WT1 and one end portion WT2s of the second flow path tube WT2 are disposed inside the first arm housing 310. A remaining portion of the first flow path tube WT1 may extend along the first rotating arm 300, and then the other end portion WT1' of the first flow path tube WT1 may be connected to the rotation link unit 500. A remaining portion of the second flow path tube WT2 may extend sequentially along the first rotating arm 300, the rotation link unit 500, and the second rotating arm 400, and then the other end portion WT2c' of the second flow path tube WT2 may be connected to a nozzle unit 600 to be described below.

The first flow path tube WT1 and the second flow path tube WT2 may each continuously extend to form respective continuous paths. Referring to FIG. 11, the second flow path tube WT2 may be divided into a first flow path portion WT2a, a second flow path portion WT2b, and a third flow path portion WT2c. In other words, the first flow path portion WT2a may also be referred to as a first path portion, the second flow path portion WT2b may also be referred to as a connection path portion, and the third flow path portion WT2c may also be referred to as a second path portion. Such division is for convenience of understanding, and the second flow path tube WT2 may actually be formed as a single tube structure made of a flexible material. Since the second flow path tube WT2 is made of a flexible material, the second flow path tube WT2 may be twisted during rotations of the first rotating arm 300 and the second rotating arm 400. In this process, a flow of water flowing along the second rotating arm 400 may be interrupted, but in the present embodiment, a degree of such twisting may be reduced or prevented through a structure of the rotation link unit 500, which will be described later.

A shaft cover part 320 surrounding upper end portions of the first hub driving shaft 130 and the second hub driving shaft 140 may be provided at one end portion of the first arm housing 310. Inside the shaft cover part 320, the sub-pulley 352 may be disposed, and one end portion of the first flow path tube WT1 and one end portion WT2s of the second flow path tube WT2 may also be disposed therein. A first guide cover part 330 surrounding a part of the rotation link unit 500 may be provided at the other end portion of the first arm housing 310. The first housing space 311 elongated in one direction is provided between the shaft cover part 320 and the first guide cover part 330.

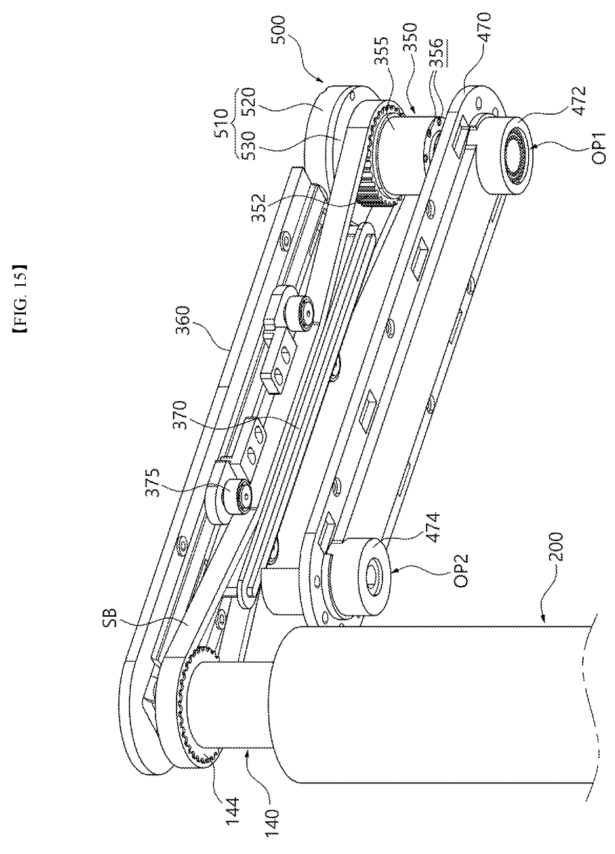

A sub-driving shaft 350 may be disposed inside the first guide cover part 330. The sub-driving shaft 350 may be formed in a substantially cylindrical shape. The sub-driving shaft 350 is a component connected to the connection pulley 144 by the sub-belt SB. More specifically, as illustrated in FIG. 15, the sub-driving shaft 350 may be provided with the sub-pulley 352, and the sub-pulley 352 may be connected to the connection pulley 144 by the sub-belt SB. The sub-driving shaft 350 may be provided with a second rotation block 355. The second rotation block 355 may be coupled to the second rotating arm 400 such that rotation of the second rotating arm 400 may operate in cooperation with rotation of the sub-driving shaft 350. Reference numeral 356 denotes an arm fastening hole for coupling the second rotation block 355 to a second arm housing 410. When the sub-driving shaft 350 is coupled to the second arm housing 410 through the arm fastening hole 356, the sub-driving shaft 350 may rotate together with the second arm housing 410.

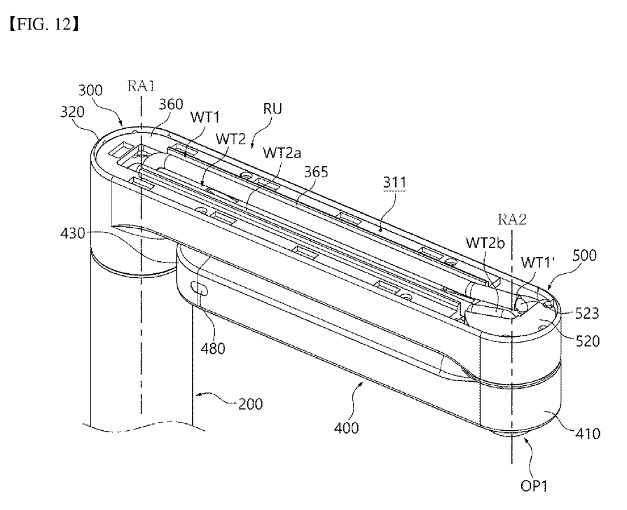

Referring again to FIGS. 10 and 11, a flow path support part 360 may be provided in the first housing space 311 of the first rotating arm 300. The flow path support part 360 may align the first flow path tube WT1 and the second flow path tube WT2 in the first housing space 311. The flow path support part 360 may include a plate-like structure extending in the same direction as the first rotating arm 300. The first flow path tube WT1 and the second flow path tube WT2 may be disposed on the flow path support part 360. As illustrated in FIG. 12, the flow path support part 360 may be provided with support ribs 365 supporting one side of the first flow path tube WT1 and one side of the second flow path tube WT2, so that the first flow path tube WT1 and the second flow path tube WT2 may be aligned in a predetermined direction between the first rotation axis RA1 and the second rotation axis RA2.

In particular, in the present embodiment, inside the first rotating arm 300, the first flow path and the second flow path may be disposed side by side to be in parallel with each other with reference to a longitudinal direction of the first rotating arm 300. More specifically, the first flow path tube WT1 forming the first flow path and the second flow path tube WT2 forming the second flow path respectively extend along directions orthogonal to the first direction, and, at the same time, the first flow path tube WT1 and the second flow path tube WT2 are disposed side by side at the same height with reference to the first direction. Referring to FIG. 12, the first flow path tube WT1 and the second flow path tube WT2 are disposed side by side in a guide slot (no reference numeral), the guide slot being a hole formed between the pair of support ribs 365. In this case, a height of the first rotating arm 300 in the first direction may be reduced, and connection of the first rotating arm 300 to the rotation link unit 500 to be described later may be improved.

A belt driving part 370 may be disposed in the first housing space 311. The belt driving part 370 may support the sub-belt SB such that the sub-belt SB may have tension equal to or greater than a predetermined level. In addition, the belt driving part 370 may be provided with a roller 375 to assist rotation of the sub-belt SB. As another example, the belt driving part 370 may be omitted. Reference numeral 390 denotes a first arm cover 390. The first arm cover 390 may be coupled to the first arm housing 310 to shield the first housing space 311.

Referring to the second rotating arm 400, the second rotating arm 400 may include the second arm housing 410. The second arm housing 410 may define a second housing space 411. A second guide cover part 420 surrounding a part of the rotation link unit 500 may be provided at one end of the second arm housing 410. The second guide cover part 420, together with the first guide cover part 330, may surround the rotation link unit 500 so that the rotation link unit 500 is not exposed. The second guide cover part 420 may have a cylindrical structure having a through-hole in the first direction.

A nozzle cover part 430 surrounding the nozzle unit 600 may be provided at the other end portion of the second arm housing 410. The nozzle cover part 430 may surround the nozzle unit 600 and may allow the nozzle unit 600 to be open only downward. Reference numeral 490 denotes a second arm cover 490. The second arm cover 490 may be coupled to the second arm housing 410 to shield the second housing space 411. However, the second arm cover 490 may allow the first water outlet part OP1 and the second water outlet part OP2 to be exposed downward.

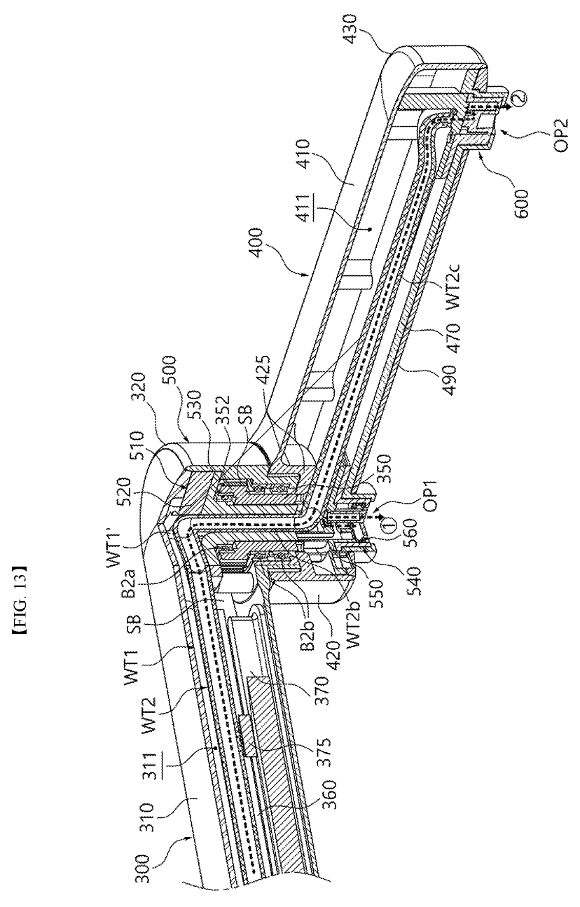

As illustrated in FIG. 11, the second arm housing 410 may be provided with a rotation support 425. The rotation support 425 may support a lower end of the sub-driving shaft 350, thereby assisting the rotation of the sub-driving shaft 350. The rotation support 425 may be coupled to the sub-driving shaft 350 such that the second rotating arm 400 rotates together with the sub-driving shaft 350. Referring to FIG. 13, the rotation support 425 supports the lower end of the sub-driving shaft 350.

The second rotating arm 400 may be provided with a water outlet frame 470. The water outlet frame 470 may be disposed in the second housing space 411. The water outlet frame 470 may serve to guide the second flow path tube WT2 and to reinforce rigidity of the second rotating arm 400. More specifically, the water outlet frame 470 may guide a direction in which the third flow path portion WT2c of the second flow path tube WT2 extends. Opposite end portions 472 and 474 of the water outlet frame 470 may respectively be open in the first direction to form the first water outlet part OP1 and the second water outlet part OP2.

Turning to the rotation link unit 500, the rotation link unit 500 may be disposed at a portion where the first rotating arm 300 and the second rotating arm 400 are connected to each other. The rotation link unit 500 may (i) form the second rotation axis RA2 to serve as a center of the rotation of the second rotating arm 400, (ii) connect the first flow path tube WT1 and the first water outlet part OP1 to form a part of the first flow path, and (iii) form a part of the second flow path while allowing the second flow path tube WT2 to pass in the first direction such that the second flow path tube WT2 is not twisted or kinked. That is, the rotation link unit 500 may constitute a part of the first flow path and a part of the second flow path. Below, description will be made focusing on these functions of the rotation link unit 500 and a structure for implementing the same.

Referring to FIG. 11, components constituting the rotation link unit 500 are illustrated in an exploded state. The rotation link unit 500 may broadly include a first flow path connector 510 and a second flow path connector 540. The first flow path connector 510 and the second flow path connector 540 may define the second rotation axis RA2. The first flow path connector 510 and the second flow path connector 540 may be coupled along an axial direction of the second rotation axis RA2. The first flow path connector 510 and the second flow path connector 540 may relatively rotate about the second rotation axis RA2.

In the present embodiment, the first flow path connector 510 may rotate together with the first rotating arm 300, and the second flow path connector 540 may rotate together with the second rotating arm 400. The first flow path connector 510 may be disposed inside the first rotating arm 300 so as to rotate together with the first rotating arm 300 and be connected to the other end portion WT1' of the first flow path. The second flow path connector 540 may be connected to the first flow path connector 510 so as to be rotatable relative thereto and may be disposed inside the second rotating arm 400 so as to rotate together with the second rotating arm 400. The second flow path connector 540 may allow the second flow path to extend along a center of the second rotation axis RA2 and then be guided toward the second rotating arm 400.

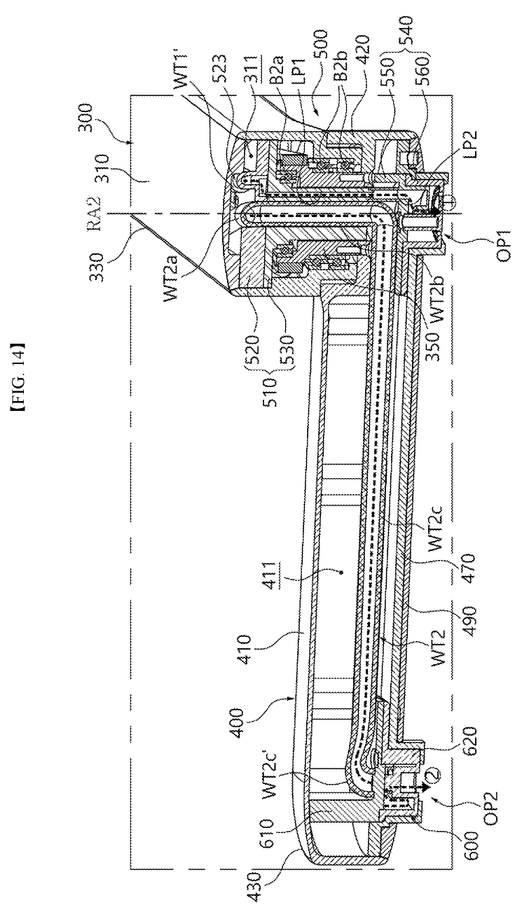

Referring to FIGS. 13 and 14, the first rotating arm 300 and the second rotating arm 400 are unfolded on opposite sides of the rotation link unit 500. In FIGS. 13 and 14, a dashed arrow ① denotes the first flow path formed by the first flow path tube WT1 and the rotation link unit 500. In FIG. 13, a part of the first flow path formed by the rotation link unit 500 is concealed. Referring to FIG. 14, first link flow paths LP1 and LP2 continuously connecting the end portion WT1' of the first flow path and the first water outlet part OP1 may be defined inside the first flow path connector 510 and the second flow path connector 540 constituting the rotation link unit 500. The first link flow paths LP1 and LP2 may be formed to be radially spaced apart from the center of the second rotation axis RA2 and connect the first flow path and the first water outlet part OP1.

The first flow path connector 510 may define a first connector path LP1 having one end connected to the first flow path and the other end open toward the second flow path connector 540. The second flow path connector 540 may define a second connector path LP2 connecting the first connector path LP1 and the first water outlet part OP1. In this case, the first connector path LP1 and the second connector path LP2 may be formed at positions radially spaced apart from the central portion of the second rotation axis RA2.

Here, the positions radially spaced apart from the central portion of the second rotation axis RA2 mean positions spaced apart from the central portion of the rotation link unit 500 in a direction orthogonal to the first direction in which the second rotation axis RA2 extends, that is, an up-down direction with reference to FIG. 14. Referring to FIG. 14, the second flow path portion WT2b of the second flow path tube WT2 may be disposed at the central portion of the rotation link unit 500, and the first connector path LP1 and the second connector path LP2 may be formed outside the second flow path portion WT2b.

Such a structure may prevent interference between the first flow path and the second flow path and may also allow the first water outlet part OP1 to be disposed on the second rotation axis RA2. When the first water outlet part OP1 is disposed on the second rotation axis RA2, a section in which the first flow path is further bent or twisted toward the second rotating arm 400 may be omitted. Accordingly, while disposing a position of the first water outlet part OP1 at a farthest position from the first rotation axis RA1, the structure of the first flow path may be simplified.

In FIGS. 13 and 14, a dashed arrow ② denotes the second flow path formed by the second flow path tube WT2. As illustrated therein, the second flow path may continuously extend through the first flow path portion WT2a, the second flow path portion WT2b, and the third flow path portion WT2c, which constitute the second flow path tube WT2. In this case, the second flow path portion WT2b may be disposed inside the rotation link unit 500. More specifically, the second flow path portion WT2b may extend along the center of the rotation link unit 500. That is, the second flow path portion WT2b may be disposed along the center of the second rotation axis RA2. In this case, even when the first rotating arm 300 and the second rotating arm 400 rotate relative to each other, twisting of the second flow path portion WT2b may be minimized in the process.

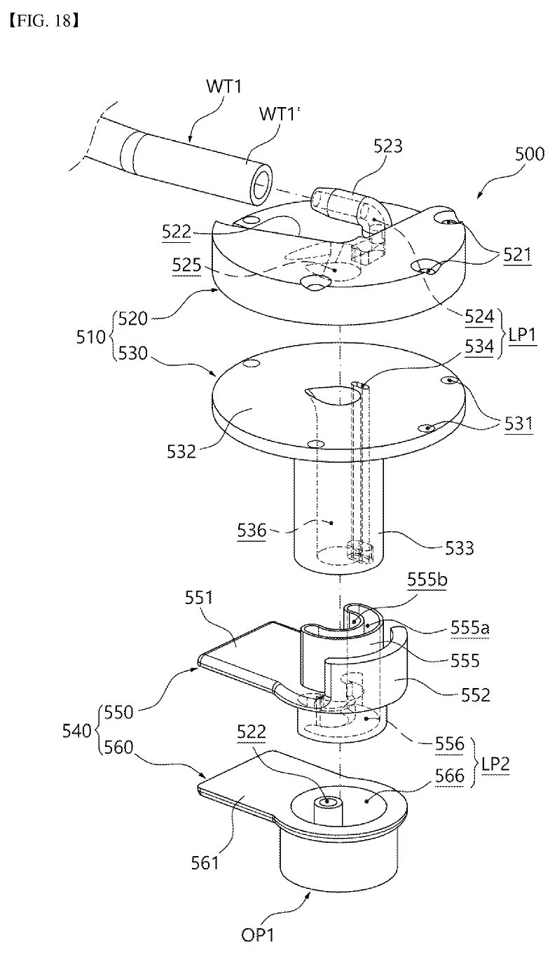

That is, the first flow path connector 510 and the second flow path connector 540 may define a second link flow path constituting a part of the second flow path along the central portion of the second rotation axis RA2. Referring to FIG. 18, the second link flow path may include a connection passage 525 and a shaft hole 536 of the first flow path connector 510, and a guide space 555b of the second flow path connector 540.

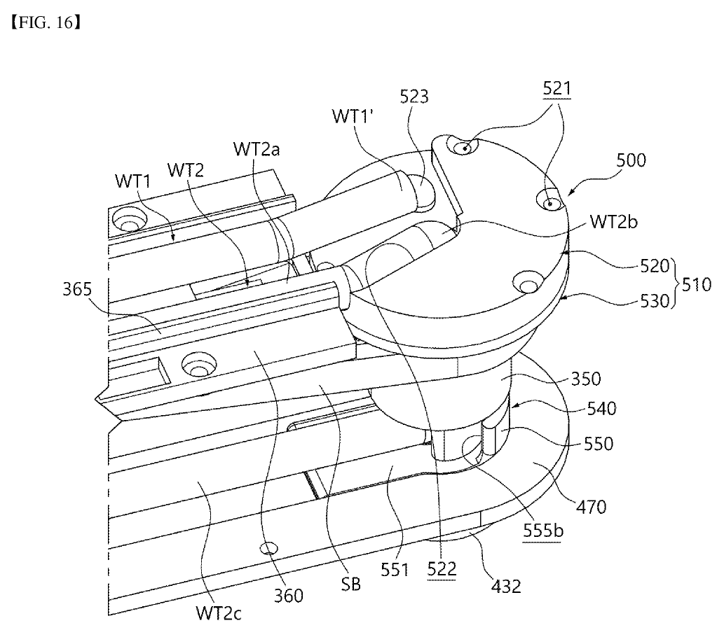

Referring to FIGS. 15 and 16, the first water outlet part OP1, the sub-driving shaft 350, and the rotation link unit 500 may be coaxially disposed along the second rotation axis RA2. The sub-driving shaft 350 may surround a part of the first water outlet part OP1. The second flow path connector 540 may be disposed below the sub-driving shaft 350. Accordingly, the first flow path connector 510 may guide the rotation of the sub-driving shaft 350.

The first water outlet part OP1 and the second water outlet part OP2 are respectively disposed at opposite end portions of the second rotating arm 400 along the second rotating arm 400. That is, the first water outlet part OP1 and the second water outlet part OP2 may be disposed at the opposite ends of the second rotating arm 400, such that the two water discharge positions may be farthest apart from each other. As illustrated in FIG. 15, the water outlet frame 470 may be provided with a first nozzle guide 472 and a second nozzle guide 474, which respectively form parts of the first water outlet part OP1 and the second water outlet part OP2.

Referring to FIG. 16, the other end portion of the first flow path tube WT1 may be connected to the first flow path connector 510. The first flow path connector 510 may be provided with a first connection port 523 into which the other end portion of the first flow path tube WT1 is inserted. When the other end portion of the first flow path tube WT1 is inserted into the first connection port 523, a continuous first flow path may be formed. The second flow path portion WT2b of the second flow path tube WT2 may be inserted at a position adjacent to the first connection port 523. The second flow path portion WT2b may pass through the central portion of the first flow path connector 510, and the first connection port 523 may be provided at a position offset from the central portion of the first flow path connector 510.

Reference numeral 522 denotes a guide fence, and the guide fence 522 may guide the first flow path tube WT1 and the second flow path tube WT2 together when the first flow path connector 510 rotates. The guide fence 522 may be formed on a stepped portion formed by recessing a part of an upper surface of the first flow path connector 510. For reference, FIG. 16 illustrates a state in which a connection block 520 and a connection shaft 530 constituting the first flow path connector 510 are coupled to each other. Fastening holes 521 may be formed in the connection block 520, and the connection block 520 may be coupled to the connection shaft 530 by separate fasteners (not shown).

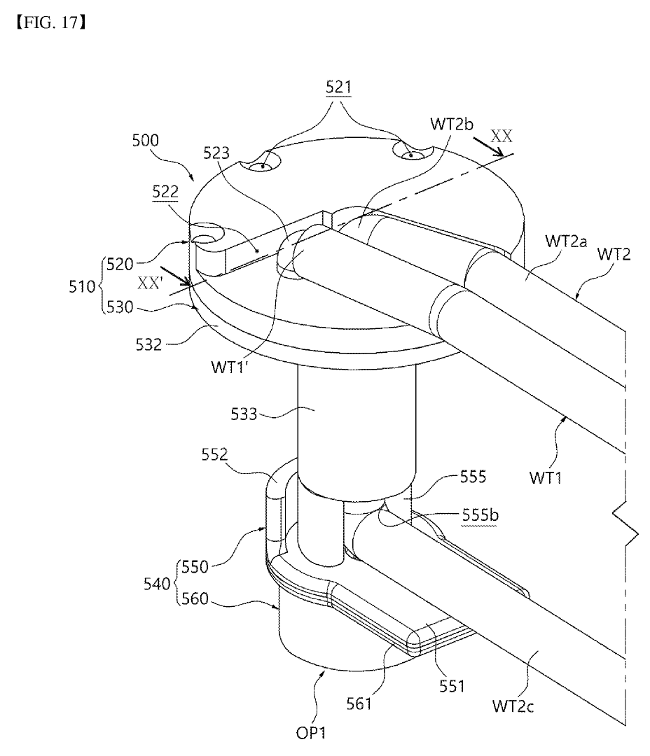

FIG. 17 illustrates only structures of the rotation link unit 500, the first flow path tube WT1, and the second flow path tube WT2, with the sub-driving shaft 350 omitted. As illustrated therein, the first flow path tube WT1 may be connected to the first connection port 523, and the second flow path tube WT2 may extend along the center of the rotation link unit 500 and then extend in a changed direction. Here, a portion extending along the center of the rotation link unit 500 may be the second flow path portion WT2b, and a portion having the changed direction after passing through the rotation link unit 500 may be the third flow path portion WT2c.

The second flow path connector 540 may allow the second flow path to extend along the center of the second rotation axis RA2 and then be guided toward the second rotating arm 400. The second flow path connector 540 may be provided with a guide sleeve 555 guiding an extending direction of the third flow path portion WT2c. A guide space 555b may be formed inside the guide sleeve 555 to surround a portion where the second flow path portion WT2b and the third flow path portion WT2c are connected.

Reference numeral 552 denotes a rotation fence part 552 provided in the second flow path connector 540, and the rotation fence part 552 may be disposed to face an inner circumferential surface of the second guide cover part 420 (shown in FIG. 14) Of the second arm housing 410. The rotation fence part 522 may extend in an arc shape and be supported by the second guide cover part 420 to guide the rotation of the rotation link unit 500.

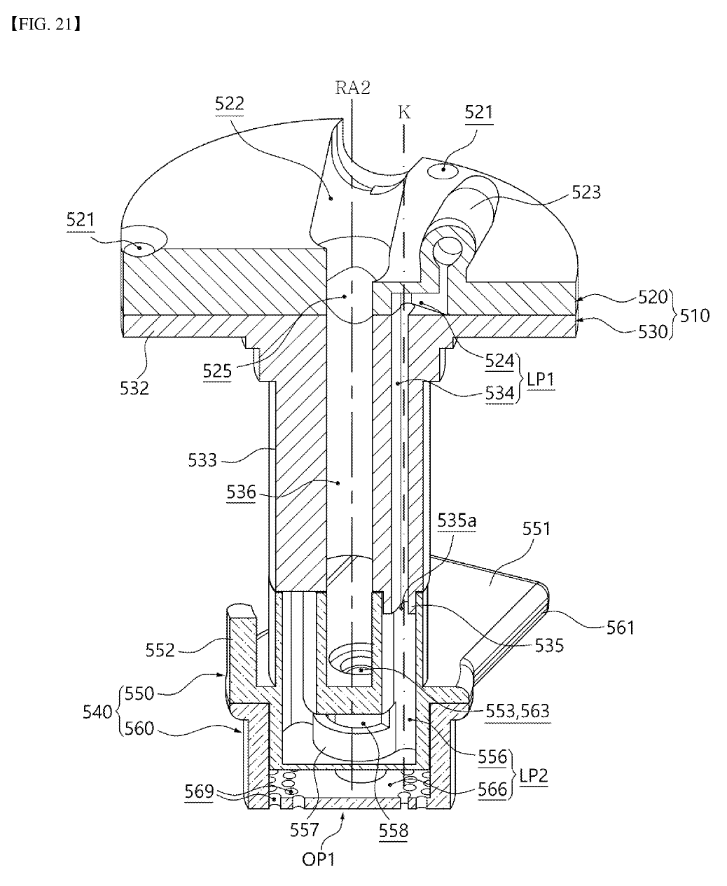

Referring to FIG. 18, all components of the rotation link unit 500 are illustrated in an exploded state. As illustrated therein, the first flow path connector 510 may include the connection block 520 and the connection shaft 530. The connection block 520 may be responsible for connection to the first flow path tube WT1, and the connection shaft 530 may form a part of the first flow path between the connection block 520 and the second flow path connector 540. The first connection port 523 may be formed in the connection block 520, and the connection passage 525 (illustrated in FIG. 21) May be formed at the center of the connection block 520. The first connection port 523 may form the first flow path, and the connection passage 525 may be connected to the shaft hole 536 of the connection shaft 530. The connection passage 525 and the shaft hole 536 may together form the second link flow path.

A port path 524 formed by the first connection port 523 and a shaft path 534 of the connection shaft 530, which will be described later, may be connected to each other to form one continuous first connector path LP1. The first connector path LP1 may be connected to the second connector path LP2 of the second flow path connector 540. In this case, the first connector path LP1 may be formed at a position offset from the center of the first flow path connector 510, and the second flow path tube WT2 may pass through the center of the first flow path connector 510.

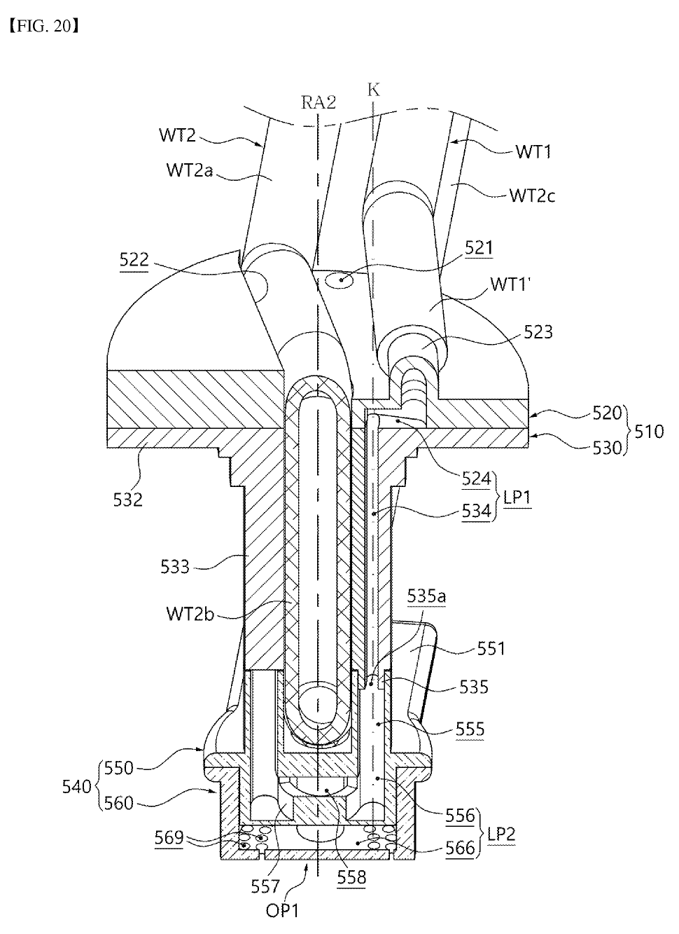

Referring to FIG. 20, an imaginary extension line extending along the first connector path LP1 and the second connector path LP2 is denoted by reference numeral K. As illustrated therein, the first connector path LP1 and the second connector path LP2 may be continuously formed at positions spaced apart in a radial direction from the centers RA2 of the first flow path connector 510 and the second flow path connector 540. Here, the centers of the first flow path connector 510 and the second flow path connector 540 are the same as the central portion of the second rotation axis RA2.

Referring again to FIG. 18, a shaft head 532 of the connection shaft 530 may be coupled to the connection block 520. The shaft head 532 may have counterpart fastening holes 531 corresponding to the fastening holes 521 so as to be fastened by fasteners. A shaft portion 533 may be connected to the shaft head 532. The shaft portion 533 may extend in the first direction and may be disposed inside the sub-driving shaft 350. A shaft hole 536 may be formed at a center of the shaft portion 533 to allow the second flow path portion WT2b of the second flow path tube WT2 to pass therethrough. The shaft path 534 may be formed radially outward of the shaft hole 536, and the shaft path 534 may continuously extend in the first direction.

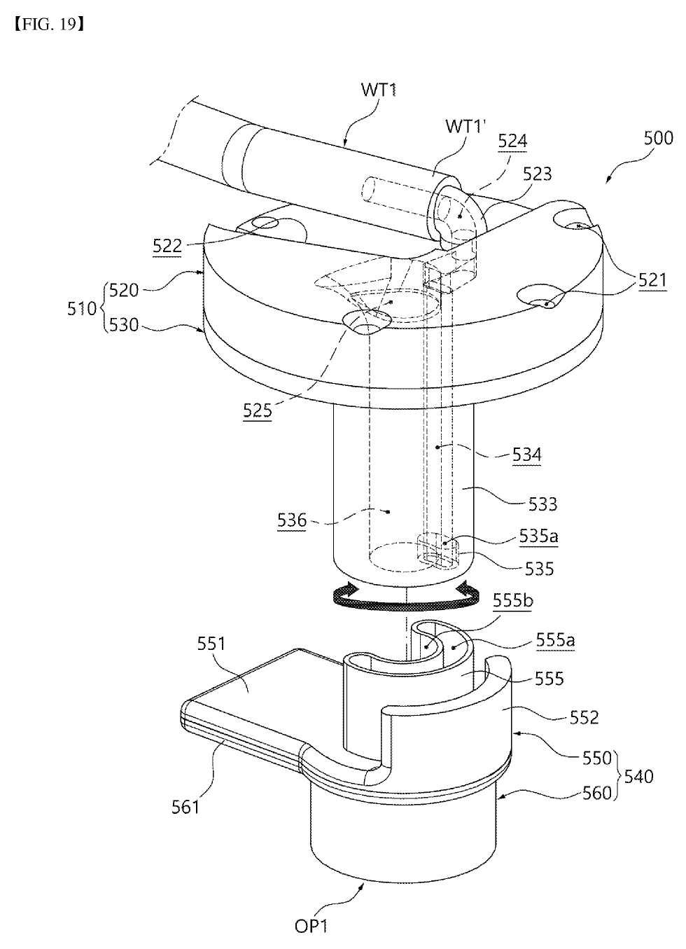

Referring to FIGS. 19 and 20, the connection shaft 530 may be provided with a guide protrusion part 535. The guide protrusion part 535 may protrude from the first flow path connector 510 in the axial direction of the second rotation axis RA2 and may form a part of the first connector path LP1 therein. More specifically, a shaft outlet 535a, which is an outlet of the shaft path 534, may be formed inside the guide protrusion part 535. Accordingly, the guide protrusion part 535 may transfer water supplied from the first flow path tube WT1 to a guide chamber 555a of the second flow path connector 540. In addition, the guide protrusion part 535 may be inserted into a rotation guide 550 of the second flow path connector 540 and may guide relative rotation of the first flow path connector 510 and the second flow path connector 540. The shaft outlet 535a may be referred to as an outlet, and the guide chamber 555a may be referred to as an inlet.

As another example, the first flow path connector 510 may be configured as a single component. That is, the first flow path connector 510 may be configured as a single component performing functions of the connection block 520 and the connection shaft 530.

Referring again to FIG. 18, the second flow path connector 540 may be disposed below the first flow path connector 510 in the first direction. The second flow path connector 540 may be connected to the first flow path connector 510 and may include the rotation guide 550 that rotates relative to the first flow path connector 510. The second flow path connector 540 may include a first nozzle 560 coupled to the rotation guide 550 and defining the first water outlet part OP1. The rotation guide 550 and the first nozzle 560 may be disposed in the direction of the second rotation axis RA2.

The rotation guide 550 may be provided with a first mounting guide 551. The first mounting guide 551 may be stacked on a second mounting guide 561 of the first nozzle 560. The first mounting guide 551 and the second mounting guide 561 may extend toward the second arm housing 410 and may be disposed in the second housing space 411. Referring to FIG. 16, the first mounting guide 551 may be disposed in the water outlet frame 470. Accordingly, the second flow path connector 540 may rotate together with the second rotating arm 400 in conjunction with the rotation of the second rotating arm 400.

Referring again to FIG. 18, the guide chamber 555a may be formed in the rotation guide 550. The guide chamber 555a may be formed along the guide sleeve 555 and may be open in the direction of the second rotation axis RA2. The guide protrusion part 535 is inserted into an inlet of the guide chamber 555a to form a continuous first flow path with the shaft path 534 formed in the guide protrusion part 535. That is, the guide chamber 555a may form the second connector path LP2 leading to the guide chamber 555a. The guide chamber 555a may be connected to a first buffer chamber 556, which will be described later, and may finally be connected to the first water outlet part OP1.

The guide chamber 555a may be formed in an arc shape along the guide sleeve 555. Here, the arc shape means a shape formed in a direction in which the second flow path connector 540 rotates relative to the first flow path connector 510. That is, since the guide sleeve 555 extends in a circumferential direction about the second rotation axis RA2, the guide chamber 555a may also extend in the circumferential direction.

When the first flow path connector 510 and the second flow path connector 540 relatively rotate, the guide protrusion part 535 may move along the inlet of the guide chamber while remaining inserted in the guide chamber 555a. In this case, the guide protrusion part 535 may be caught by opposite end portions of the rotation guide 550, so that a relative rotation angle between the first rotating arm 300 and the second rotating arm 400 may be limited. That is, the guide protrusion part 535 may be caught by the opposite ends of the guide chamber 555a, respectively, so that a relative rotation angle between the first flow path connector 510 and the second flow path connector 540 may be limited, and, as a result, the relative rotation angle between the first rotating arm 300 and the second rotating arm 400 may be limited.

Referring to FIG. 21, fastening holes 553 and 563 connected to each other may be formed in the rotation guide 550 and the first nozzle 560. When a fastener (not shown) is fastened to the fastening holes 553 and 563, the rotation guide 550 and the first nozzle 560 may be coupled to each other. As another example, the second flow path connector 540 may be configured as a single component. That is, the second flow path connector 540 may be configured as a single component performing functions of the rotation guide 550 and the first nozzle 560.

The first buffer chamber 556 may be formed in the first nozzle 560. The first buffer chamber 556 may be connected to the guide chamber 555a to form the first flow path and may also be connected to a first discharge hole 569 serving as an outlet of the first water outlet part OP1. The first buffer chamber 556 may be regarded as being defined inside the rotation guide 550. The first buffer chamber 556 may allow water supplied through the first flow path to be collected and then discharged to the outside. That is, the first buffer chamber 556 may guide water having passed through the first flow path such that the water is not immediately discharged through the first discharge hole 569 but is discharged after being collected to some extent. Accordingly, the first buffer chamber 556 may be regarded as a kind of reservoir chamber.

Referring to FIGS. 20 to 22, the first buffer chamber 556 may be formed inside the rotation guide 550. The first buffer chamber 556 may be connected to a first nozzle chamber 566 formed in the first nozzle 560 and may form one continuous second connector path LP2. In this case, a first baffle wall 557 may be disposed between the first buffer chamber 556 and the first nozzle chamber 566. Accordingly, after water is collected in the first buffer chamber 556, the water may pass over the first baffle wall 557 and be delivered to the first nozzle chamber 566. A passage 558 may be formed between the first buffer chamber 556 and the first nozzle chamber 566, and the passage 558 may form a part of the second connector path LP2. The passage 558 will be described again below.

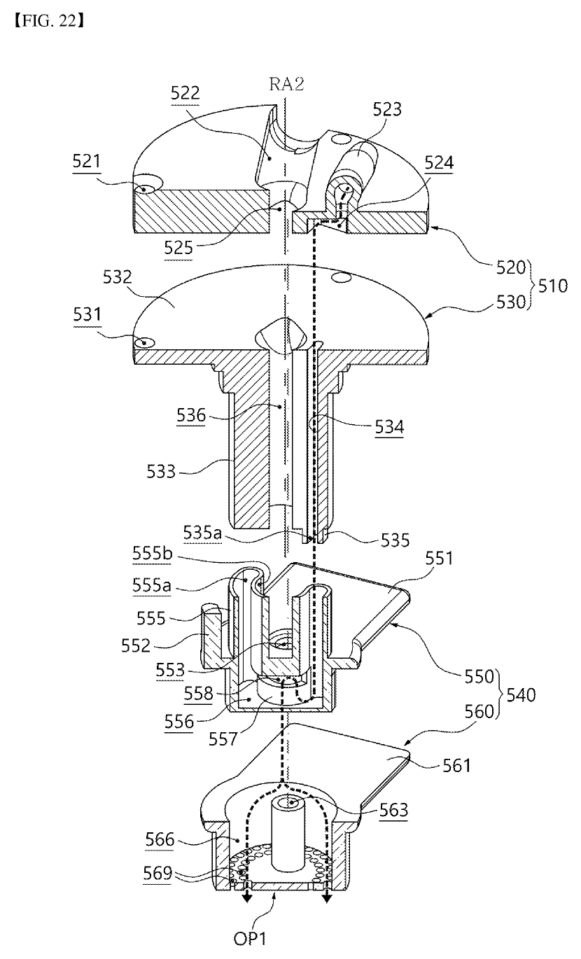

Referring to the first flow path indicated by a dashed line in FIGS. 21 and 22, water passing through the first flow path tube WT1 and the first connector path LP1 may flow along the shaft outlet 535a and the guide chamber 555a. Subsequently, the water introduced into the first buffer chamber 556 may be collected in the first buffer chamber 556. The collected water may pass over the first baffle wall 557 and be delivered to the first nozzle chamber 566 and be finally discharged through the first discharge hole 569. Accordingly, it may be said that the first nozzle 560 defines the first water outlet part OP1.

This first flow path may be formed in a direction of the second rotation axis RA2 along a position offset from central portions of the first flow path connector 510 and the second flow path connector 540. Even though the first flow path is formed at a position offset from the central portion of the rotation link unit 500, the first flow path may remain connected without being disconnected during relative rotation of the first rotating arm 300 and the second rotating arm 400. This is because the guide protrusion part 535 of the first flow path connector 510 described above relatively rotates along the inlet of the guide chamber while remaining inserted in the guide chamber 555a of the second flow path connector 540, and, in this case, the guide protrusion part 535 and the guide chamber 555a form the continuous first flow path.

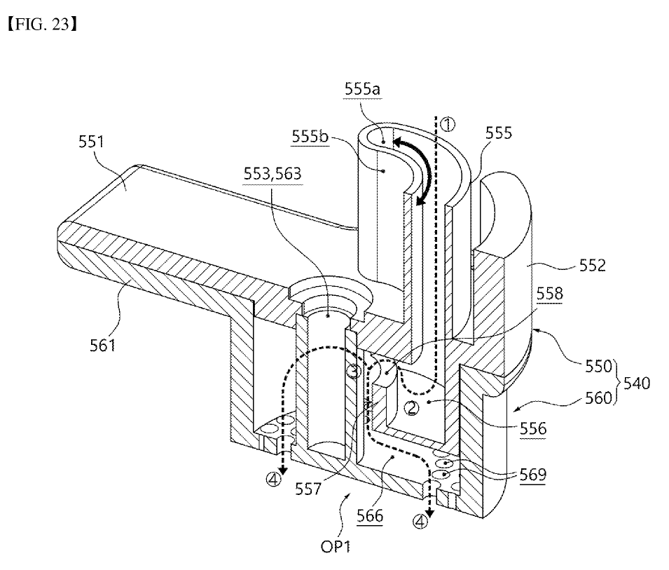

Referring to FIG. 23, a water discharge process of the first water outlet part OP1 will be described in more detail. A path of water flowing into the guide chamber 555a is indicated by arrow ①. Since the guide chamber 555a extends in a direction of arrow ①, that is, in a circumferential direction, water may flow into the guide chamber 555a regardless of a position of the guide protrusion part 535 (not shown in FIG. 23.

The water introduced in this manner may be collected in the first buffer chamber 556. A direction in which the water is collected is indicated by arrow ②. The water filled in the first buffer chamber 556 may be required to pass over the first baffle wall 557, and this path is indicated by arrow ③. Reference numeral 558 denotes a passage formed between an upper end of the first baffle wall 557 and a surface of the rotation guide 550. The passage 558 may connect the first buffer chamber 556 and the first nozzle chamber 566.

Water that has passed over the first baffle wall 557 and through the passage 558 may be delivered to the first nozzle chamber 566 and discharged through the first discharge hole 569 along a direction of arrow ④. In this case, even when a flow rate through the first flow path increases, formation of a strong water pressure at the first discharge hole 569 may be prevented. That is, since water is collected in the first buffer chamber 556 around the first discharge hole 569 and is then discharged, formation of a strong stream of water biased toward one side may be prevented.

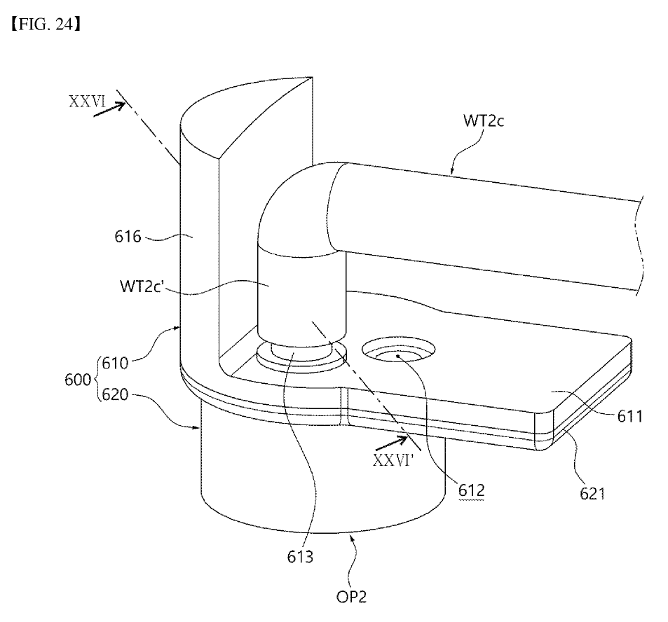

Referring to FIG. 24, the second flow path tube WT2 is illustrated as being connected to the nozzle unit 600 constituting the second water outlet part OP2. As illustrated therein, the end portion WT2c' of the second flow path tube WT2, that is, the end portion WT2c' of the third flow path portion WT2c, may be fitted into the nozzle unit 600 to form a continuous second flow path up to the second water outlet part OP2. The nozzle unit 600 may be disposed inside the nozzle cover part 430 of the second rotating arm 400 and may not be exposed.

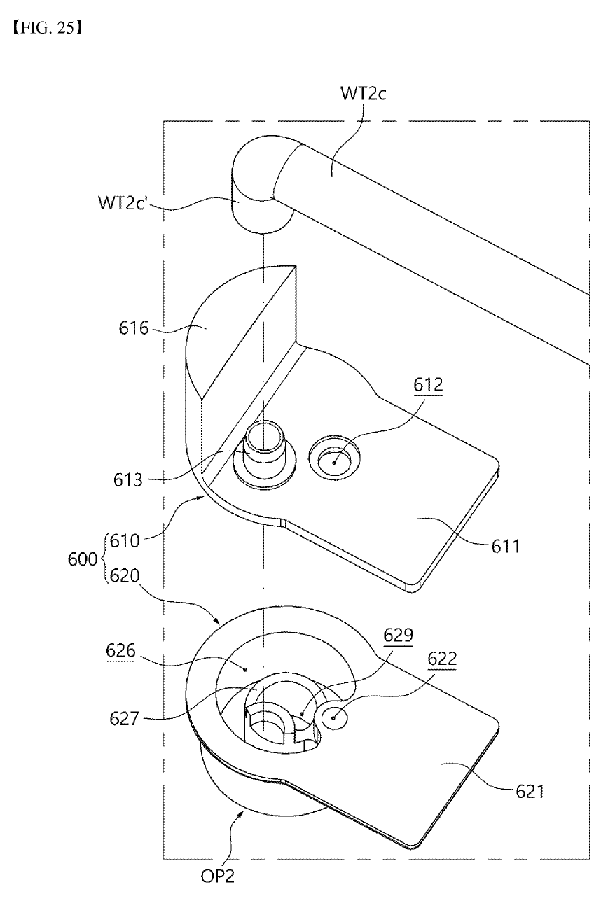

Referring to FIGS. 24 and 25, the structure of the nozzle unit 600 will be described. The nozzle unit 600 may include a connection body 610 connected to the second flow path tube WT2, and a nozzle body 620 coupled to the connection body 610. The connection body 610 and the nozzle body 620 may be coupled to each other in the first direction, which is a water discharge direction of the second water outlet part OP2. The connection body 610 and the nozzle body 620 may be coupled to each other to constitute the second water outlet part OP2. As another example, the connection body 610 and the nozzle body 620 may be integrally formed.

The connection body 610 may be provided with a first alignment guide 611. The first alignment guide 611 may be stacked on a second alignment guide 621 provided on the nozzle body 620. The first alignment guide 611 and the second alignment guide 621 may together constitute one alignment guide 611 and 621 and be disposed in the second housing space 411 of the second arm housing 410. In this case, the one alignment guides 611 and 621 may fix an installation direction of the nozzle unit 600, and the nozzle unit 600 may also rotate together during rotation of the second rotating arm 400.

Corresponding fixing holes 612 and 622 may be formed in the connection body 610 and the nozzle body 620. The fixing holes 612 and 622 may be aligned in the first direction to allow one fastener, such as a screw (not shown), to pass therethrough.

The connection body 610 may be provided with a second connection port 613. The second connection port 613 may be a portion into which the end portion WT2c' of the second flow path tube WT2 is fitted. More specifically, the end portion WT2c' of the third flow path portion WT2c may be fitted into the second connection port 613 to form a continuous flow path.

A second buffer chamber 626 may be formed in the nozzle unit 600. The second buffer chamber 626 may be connected to the second flow path tube WT2 to form the second flow path and may also be connected to a second discharge hole 629 serving as an outlet of the second water outlet part OP2. The second buffer chamber 626 may be regarded as being defined inside the nozzle body 620. The second buffer chamber 626 may allow water supplied from the second flow path tube WT2 to be collected and then discharged to the outside. That is, the second buffer chamber 626 may guide water having passed through the second flow path such that the water is not immediately discharged through the second discharge hole 629 but is discharged after being collected to some extent. Accordingly, the second buffer chamber 626 may be regarded as a kind of reservoir chamber.

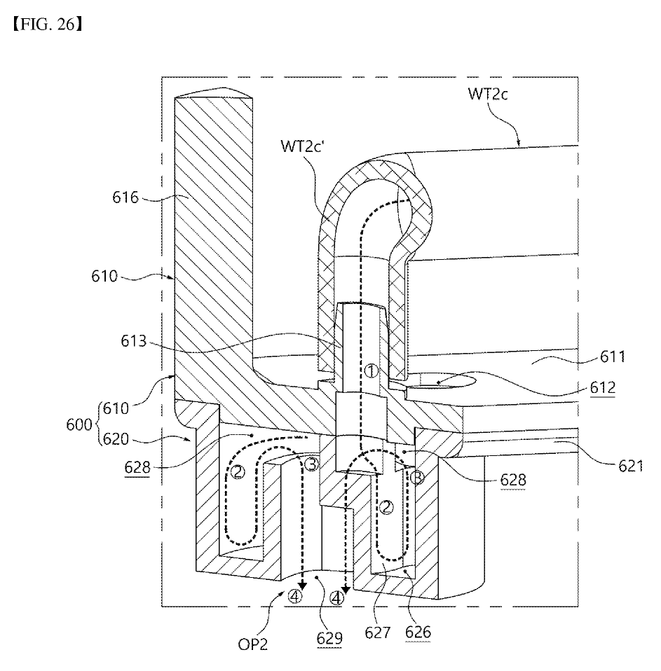

Referring to FIGS. 25 and 26, the second buffer chamber 626 may be formed inside the nozzle body 620. In this case, a second baffle wall 627 may be disposed between the second buffer chamber 626 and the second discharge hole 629. Accordingly, after water is collected in the second buffer chamber 626, the water may pass over the second baffle wall 627 and be delivered to the second discharge hole 629.

Referring to FIG. 26, a water discharge process of the second water outlet part OP2 will be described in more detail. A path along which water having passed through the second flow path tube WT2 passes through the second connection port 613 is indicated by arrow ①. The water introduced in this manner may be collected in the second buffer chamber 626. A direction in which the water is collected in the second buffer chamber 626 is indicated by arrow ②. The water filled in the second buffer chamber 626 may be required to pass over the second baffle wall 627, and this path is indicated by arrow ③. Reference numeral 628 denotes a passage formed between an upper end of the second baffle wall 627 and a lower surface of the connection body 610. The passage 628 may connect the second buffer chamber 626 and the second discharge hole 629.

Water having passed over the second baffle wall 627 and through the passage 628 may be delivered toward the second discharge hole 629 and discharged to the outside of the second discharge hole 629 along a direction of arrow ④. In this case, even when a flow rate through the second flow path increases, formation of a strong water pressure at the second discharge hole 629 may be prevented. That is, since water is collected in the second buffer chamber 626 around the second discharge hole 629 and is then discharged, formation of a strong stream of water biased toward one side may be prevented.

Meanwhile, the second rotating arm 400 may be provided with a proximity sensor 480 configured to detect a distance between the second rotating arm 400 and a surrounding object. The proximity sensor 480 may be disposed on at least one of left and right-side surfaces of the second rotating arm 400 adjacent to the second water outlet part OP2. In the present embodiment, the proximity sensor 480 may be provided on each of both left and right-side surfaces of the second rotating arm 400 adjacent to the second water outlet part OP2. The proximity sensor 480 may prevent collision between the first rotating arm 300 and the second rotating arm 400 and surrounding objects or structures. As another example, the proximity sensor 480 may be provided on the first rotating arm 300 or may be provided on each of the first rotating arm 300 and the second rotating arm 400.

On the basis of information acquired through the proximity sensor 480 or the camera C (illustrated in FIG. 2), the drive controller may drive the linear driving motor SM to move the first rotating arm 300 and the second rotating arm 400 to a maximum height. In addition, the drive controller may rotate the second rotating arm 400 by 180 degrees to unfold the second rotating arm 400 to a maximum length. In this process, the drive controller may recognize a shape, a position, and a height of an object through the camera C while rotating the first rotating arm 300 up to 180 degrees.

On the basis of information obtained from the proximity sensor 480, when collision with an object is expected, the drive controller may stop an operation and may notify a user of the expected collision through the lighting device 390.

The drive controller may calculate a height and a size of an object by triangulation on the basis of a relative distance between the camera C disposed on the second rotating arm 400 and the object, a rotational speed of the second rotating arm 400, and a distance to an upper plate portion of the sink 10. When a position and a size of the object are identified through the camera C of the second rotating arm 400, the drive controller may fold the second rotating arm 400 clockwise back to 0 degrees to restore an original shape thereof.

The drive controller may move the first water outlet part OP1 of the first rotating arm 300 to a center position of a target object, for example, a container, and may cause the lighting device 390 to emit light of an identified color to inform a user that water is for washing. In addition, the drive controller may repeatedly rotate the first water outlet part OP1 clockwise or counterclockwise within an inner range of a target object, for example, a bowl, while discharging water for washing through the first water outlet part OP1.

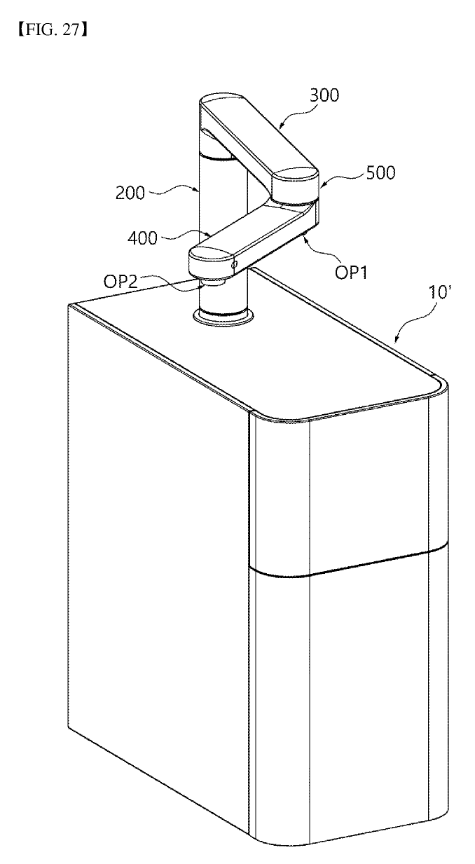

Referring to FIG. 27, the water supply device according to the present disclosure is illustrated as being applied to a water purifier 10'. As illustrated therein, the first rotating arm 300, the second rotating arm 400, and the base column 200 according to the present disclosure may be applied to a main body of the water purifier 10'. In this case, the water purifier 10' may supply water to a user at various positions and heights through operations of the first rotating arm 300, the second rotating arm 400, and the base column 200.

The above description is merely illustrative of the technical idea of the present disclosure, and those skilled in the art to which the present disclosure pertains will be able to make various modifications and alterations without departing from the essential characteristics of the present disclosure. Accordingly, the embodiments disclosed in the present disclosure are provided for the purpose of illustration and are not intended to limit the technical concept of the present disclosure, and the scope of the technical idea of the present disclosure is not limited by these embodiments. The scope of protection of the present disclosure should be interpreted on the basis of the claims set forth below, and all technical ideas within the equivalent scope should be construed as being included within the scope of the present disclosure.

What is claimed is:

1. A water supply device comprising:
a base column;
a first rotating arm configured to rotate about the base column as a first rotation axis;
a second rotating arm connected to a second rotation axis rotating together with the first rotating arm, and configured to rotate about the second rotation axis independently of the first rotation axis;
a supply flow path extending inside the first rotating arm and the second rotating arm;
a water outlet part disposed on the second rotating arm and configured to receive water through the supply flow path and discharge the water to an outside; and
a driving unit configured to rotate the first rotating arm and the second rotating arm.

2. The water supply device of claim 1, wherein inside the first rotating arm, a first flow path and a second flow path are disposed side by side to be parallel to each other with reference to a longitudinal direction of the first rotating arm.

3. The water supply device of claim 1, wherein the base column extends in a first direction, and
the first rotation axis and the second rotation axis are respectively formed in directions parallel to the first direction.

4. The water supply device of claim 1, wherein the base column extends in a first direction,
wherein the base column is linearly moved in the first direction by the driving unit.

5. The water supply device of claim 1, wherein the water outlet part comprises:
a first water outlet part connected to a first flow path extending inside the first rotating arm and the second rotation axis, and having a water discharge position variable according to an angular position of the first rotating arm; and
a second water outlet part connected to a second flow path extending inside the first rotating arm, the second rotation axis, and the second rotating arm, and having a water discharge position variable according to the angular position of the first rotating arm and an angular position of the second rotating arm.

6. The water supply device of claim 5, wherein the second rotation axis is formed by a rotation link unit connecting the first rotating arm and the second rotating arm, and
the first water outlet part is disposed at a lower end portion of the rotation link unit.

7. The water supply device of claim 5, wherein the second rotation axis is formed by a rotation link unit connecting the first rotating arm and the second rotating arm, and
the second water outlet part is disposed at an end portion of the second rotating arm so as to be radially spaced apart from the rotation link unit.

8. The water supply device of claim 5, wherein the first flow path is defined by a first flow path tube disposed inside the first rotating arm and a rotation link unit connecting the first rotating arm and the second rotating arm, and
the second flow path is defined by a second flow path tube continuously disposed inside the first rotating arm, inside the rotation link unit, and inside the second rotating arm.

9. The water supply device of claim 5, wherein the second rotation axis is formed by a rotation link unit connecting the first rotating arm and the second rotating arm, and
the second flow path passes through an inside of the rotation link unit to form a continuous path from the first rotating arm to the second rotating arm.

10. The water supply device of claim 5, wherein the second rotation axis is formed by a rotation link unit connecting the first rotating arm and the second rotating arm, and
the second flow path extends inside the rotation link unit in an axial direction of the second rotation axis along a central portion of the second rotation axis.

11. The water supply device of claim 5, wherein the first rotating arm and the second rotating arm are connected to each other by a rotation link unit, and
the second flow path comprises:
a first path portion extending inside the first rotating arm;
a second path portion extending inside the second rotating arm and having an end connected to the second water outlet part; and
a connection path portion connecting the first path portion and the second path portion and extending inside the rotation link unit.

12. The water supply device of claim 5, wherein the first rotating arm and the second rotating arm are connected to each other by a rotation link unit,
wherein the rotation link unit comprises:
a first link flow path formed to be radially spaced apart from a center of the second rotation axis, and connecting the first flow path and the first water outlet part; and
a second link flow path formed coaxially with the center of the second rotation axis, and configured to guide the second flow path along a direction of the second rotation axis.

13. The water supply device of claim 5, further comprising:
a first flow path connector configured to rotate together with the first rotating arm; and
a second flow path connector configured to rotate together with the second rotating arm and aligned with the first flow path connector in a direction of the second rotation axis,
wherein the first flow path connector and the second flow path connector constitute a part of the first flow path along an axial direction of the second rotation axis at a location radially offset from a central portion of the second rotation axis, and
wherein the first flow path connector and the second flow path connector constitute a part of the second flow path along the central portion of the second rotation axis.

14. The water supply device of claim 5, further comprising:
a first flow path connector connected to an end portion of the first flow path, disposed on the second rotation axis, and configured to rotate together with the first rotating arm; and
a second flow path connector connected to the first flow path connector so as to be rotatable relative thereto, configured to rotate together with the second rotating arm about the second rotation axis, and configured to guide a path of the second flow path toward the second rotating arm,
wherein the first water outlet part is formed in the second flow path connector.

15. The water supply device of claim 5, wherein a buffer chamber is formed in the first water outlet part or the second water outlet part to allow water supplied from the first flow path and the second flow path to be collected and then discharged to the outside.

16. The water supply device of claim 5, further comprising:
a driving frame in which the driving unit is disposed,
wherein the driving unit comprises:
a linear driving source configured to move the base column in a first direction; and
a rotation driving source configured to rotate the first rotating arm and the second rotating arm,
wherein the linear driving source is configured to be fixed to the driving frame, and
the rotation driving source is configured to be moved in the first direction together with the base column by the linear driving source.

17. The water supply device of claim 5, wherein the first water outlet part is configured to rotate together with the first rotating arm such that the water discharge position of the first water outlet part is variable according to the angular position of the first rotating arm, and
the second water outlet part is configured to rotate together with the second rotating arm such that the water discharge position of the second water outlet part is variable according to the angular position of the first rotating arm, the angular position of the second rotating arm, or a combination of the angular position of the first rotating arm and the angular position of the second rotating arm.

18. The water supply device of claim 13, wherein the second flow path connector has an inlet opening connected to an outlet of the first flow path connector,
wherein the outlet or the inlet extends continuously in a circumferential direction corresponding to relative rotation between the first flow path connector and the second flow path connector, so that the outlet and the inlet remain connected to each other during the relative rotation between the first flow path connector and the second flow path connector.

19. The water supply device of claim 14, wherein the second flow path connector comprises:
a rotation guide connected to the first flow path connector and configured to rotate relative to the first flow path connector; and
a first nozzle coupled to the rotation guide and defining the first water outlet part,
wherein a first buffer chamber is formed in the rotation guide and the first nozzle to allow water supplied from the first flow path to be collected and then discharged to the outside.

20. A water supply device comprising:
a base column;
a first rotating arm configured to rotate about the base column as a first rotation axis;
a second rotating arm connected to a second rotation axis rotating together with the first rotating arm, and configured to rotate about the second rotation axis independently of the first rotation axis;
a first water outlet part connected to a first flow path extending inside the first rotating arm and the second rotation axis, and having a water discharge position variable according to an angular position of the first rotating arm;
a second water outlet part connected to a second flow path extending inside the first rotating arm, the second rotation axis, and the second rotating arm, and having a water discharge position variable according to the angular position of the first rotating arm and an angular position of the second rotating arm; and
a driving unit configured to rotate the first rotating arm and the second rotating arm.
